(19) United States
(12) Patent Application Publication
(10) Pub. No.: US 2011/0217623 A1
(43) Pub. Date: Sep. 8, 2011

(54) PROTON EXCHANGE MEMBRANE FOR FUEL CELL APPLICATIONS

(75) Inventors: San Ping Jiang, Singapore (SG); Haolin Tang, Singapore (SG); Ee Ho Tang, Singapore (SG); Shanfu Lu, Singapore (SG)

(73) Assignees: NANYANG TECHNOLOGICAL UNIVERSITY, Singapore (SG); DEFENCE SCIENCE & TECHNOLOGY AGENCY, Singapore (SG)

(21) Appl. No.: 12/991,377

(22) PCT Filed: May 5, 2009
(86) PCT No.: PCT/SG2009/000160

§ 371 Date: May 24, 2011

Related U.S. Application Data
(60) Provisional application No. 61/050,368, filed on May 5, 2008.

(51) Int. Cl. H01M 8/12; H01M 8/00; C08J 5/20; B05D 5/12

(52) U.S. Cl. 429/495; 521/27; 427/115

(57) ABSTRACT

The present invention refers to an inorganic proton conducting electrolyte consisting of a mesoporous crystalline metal oxide matrix and a heteropolyacid bound within the mesoporous matrix. The present invention also refers to a fuel cell including such an electrolyte and methods for manufacturing such inorganic electrolytes.

### CROSS-REFERENCE TO RELATED APPLICATIONS

This application claims benefit of priority of U.S. provisional application No. 61/050,368, filed May 5, 2008, the contents of it being hereby incorporated by reference in its entirety for all purposes.

### FIELD OF THE INVENTION

The present invention relates generally to fuel cell technology, in particular to the field of proton exchange membranes for fuel cells operating at elevated temperatures.

### BACKGROUND OF THE INVENTION

Polymer electrolyte fuel cells (PEMFCs), which employ proton exchange membranes (PEMs), are considered to be promising sources of electrical energy. An advantage of a PEMFC is its high-energy conversion efficiency and simplicity in design, resulting in reliability and convenience.

A PEMFC consists of a proton-conducting polymer membrane, such as Nafion®, sandwiched between two electrodes. In general, fuel cells generate electricity from a simple electrochemical reaction in which an oxidizer, typically oxygen from air, and a fuel, typically hydrogen, combine to form a product, which is water for the typical fuel cell. Oxygen (air) continuously passes over the cathode and hydrogen passes over the anode to generate electricity, by-product heat and water. The electrolyte that separates the anode and cathode is an ion-conducting material. At the anode, hydrogen and its electrons are separated so that the hydrogen ions (protons) pass through the electrolyte while the electrons pass through an external electrical circuit as a Direct Current (DC) that can power useful devices. The hydrogen ions combine with the oxygen at the cathode and are recombined with the electrons to form water. Thus, in principle, a fuel cell operates like a battery. Unlike a battery however, a fuel cell does not run down or require recharging. It will produce electricity and heat as long as fuel and an oxidizer are supplied.

Different combinations of fuel and oxidant are possible. For example, a hydrogen fuel cell uses hydrogen as fuel and oxygen as oxidant while an alcohol fuel cell can use for example alcohols as fuel.

Existing PEMFCs are attractive for a variety of power applications but must operate near ambient temperature because at elevated temperatures above 80° C., dehydration of Nafion® occurs, resulting in deactivation of the material. Moreover, the low operating temperature makes the noble metal-based anode catalyst susceptible to poisoning by contaminants in the fuel stream. Thus, operation of the fuel cell at higher temperatures can reduce the need for noble metal catalysts and the effect of CO poisoning.

CO poisoning can for example occur when for the operation of a hydrogen fuel cell hydrogen gas is used which is not pure. Due to the high costs, in general hydrogen gas is used which is produced by steam reforming light hydrocarbons. This is a process which produces a mixture of gasses that also contains CO, CO₂ and N₂. Even small amounts of CO can poison a pure noble metal catalyst. Therefore, high-temperature (100-300° C.) proton exchange membrane fuel cells (PEMFCs) have received worldwide attention because at elevated operation temperatures the CO coverage at the surface of the catalyst is reduced. At high temperatures CO does not constitute a poison for the fuel cell but can instead be used directly as fuel for the high temperature fuel cell.

Direct methanol fuel cells also benefit from improved oxidation kinetics at elevated temperatures, and direct ethanol becomes a viable fuel in the range of 150 to 300° C. In addition, the thermal enhancement for redox activity allows for the exploration of alternative catalysts which do not function well at lower temperatures.

The development of alternative electrocatalysts, particularly those based on non-precious metal catalysts is critical for the commercial viability of PEMFC technologies. Operating at high temperatures has also the advantage of creating a greater driving force for more efficient cooling. This is particularly important for transport applications to reduce balance of plant equipment. Furthermore, high grade exhaust heat can be integrated into fuel processing stages. Operation of a fuel cell at ambient pressure and elevated temperatures strongly indicates that an optimal high temperature membrane would be one whose proton conductivity is not or less dependent on the presence of water. PEMFCs based on perfluorosulfonic acid polymer (PFSA) electrolyte such as Nafion® cannot be operated at temperatures higher than 100° C. owing to the dehydration or volatility of water at an elevated temperature. The hydration of the membrane is crucial for the PEMFC performance since proton conductivity of the sulfonic polymer PEMs decreases drastically under dehydration.

Several approaches have been proposed to develop high-temperature membranes for fuel cell application. One of the approaches is to imbibitions the PFSA membranes with hygroscopic inorganic particles such as silica, TiO₂ or zeolite that could retain water at elevated temperatures above 100° C. The maximum temperature achieved is 145° C. for a Nafion®/TiO₂ composite membrane in a pressurized DMFC. The leaching of ionic liquid from swollen Nafion® membrane under fuel cell operating conditions is a serious concern. Further increase of operation temperature was restricted by the H⁺ form PFSA glass transformation temperature (T_{g}, 120˜130° C.) and the decomposition of the PFSA polymer.

Another approach for high temperature (150-200° C.) membranes is to replace water with other proton conductor such as phosphoric acid fixed in polymeric matrix, for example, a polybenzimidazole (PBI)/phosphoric acid system. However, phosphoric acid is potentially soluble with the production of water in the fuel cell working condition and stability of hybrid PBI/phosphoric acid is also a concern.

The heteropolyacid (HPA) are known superionic conductors in their fully hydrated states. HPAs are solid crystalline materials with polyoxometalate inorganic cage structures, which may adopt the Keggin form with general formula H₃MX₁₂O₄₀, where M is the central atom and X the heteroatom. Typically M can be either P or Si, and X=W or Mo. The highest stability and strongest acidity is observed for phosphotungstic acid (H₃PW₁₂O₄₀, abbreviated as HPW or PWA). For the fully hydrated Keggin structure, it is speculated that channels around the anions can contain up to 29 water molecules, only six of which occupy ordered sites on the bridging oxygen atoms. The remainder is able to form multiple protonic species, with varying hydrogen bond strengths. Conductivity decreases with increasing temperature, as coordinating waters are lost. TGA analysis of various HPAs shows that secondary waters are retained to temperatures as high as 350° C., indicating the possibility of proton conductivity at high temperatures. FIG. 22 shows the Keggin structure of HPW.

Sweikart, M. A. et al. (2005, J. Electrochemical Society, vol. 152, pp. A98) mixed HPW with a high temperature and sulfonated epoxy to form a composite membrane. The maximum conductivity for HPW-doped sulfonated epoxy is 1.31×10⁻⁵ S/cm at 200° C. The cell performance fabricated from the HPW-doped sulfonated epoxy composite membrane is very low due to the low conductivity. Tan, A. R., et al. (2005, Macromolecular Symposia, vol. 229, pp. 168) studied the composite polymer membranes based on sulfonated poly(arylene ether sulfone) (SPSU) containing benzimidazole derivatives (BlzD) and heteropolyacid for use in fuel cells. The problem of bleeding out of HPW from the composite membrane is decreased with the addition of BlzD. A proton conductivity of 0.159 S/cm was obtained for the composite membrane at a maximum temperature of 110° C. in water vapor in a sealed vessel. Uma, T., et al. (2006, Materials Research Bulletin, vol. 41, pp. 817) prepared sol-gel derived P₂O₅—SiO₂—H₃PMo₁₂O₄₀ glass membrane by heating treated at 600° C. A maximum power density of 24 mW/cm² was reported for operation with H₂/O₂ at 30° C. and 30% humidity with a P₂O₅—SiO₂—H₃PMo₁₂O₄₀ (4-92-4 mol. %) glass membrane.

An organic-inorganic hybrid membrane containing HPA has also been investigated as potential proton conducting membrane electrolyte for fuel cells. Nakanishi, T., et al. (2007, Macromolecules, vol. 40, pp. 4165) prepared HPW/TES-Oct composite membrane by hydrolysis and condensation reactions, using 1,8-bis(triethoxysilyl)octane (TES-Oct) precursor in the presence of HPW with hydrated water and obtained an amorphous silica membrane.

The proton conductivity was in the range of 10⁻⁴ and 10⁻² S/cm at 80° C. under 95% RH. Yamada, M., et al. (2006, J Physical Chemistry B, vol. 110, pp. 20486) reported a preparation of HPW/polyelectrolyte of polystyrene sulfonic acid (PSS) by self-assembly of —SO₃H of PSS onto the PWA surface. The HPW/PSS composite membrane exhibits a proton conductivity of 1×10⁻² S/cm at 180° C. without humidification. However, such composite membrane would be limited to temperature lower than 200° C. due to the thermal stability of PSS polyelectrolytes. One of the major problems for the hybrid membranes containing HPA as described so far is the leaking out of dopant from the matrix. Since HPW is water soluble material, it would be easily removed from the hybrid membrane in the presence of water.

It is therefore an object of the present invention to provide an alternative electrolyte which can be used for fuel cell applications.

### SUMMARY OF THE INVENTION

In a first aspect, the present invention is directed to an inorganic proton conducting electrolyte consisting of a mesoporous crystalline metal oxide matrix and a heteropolyacid bound within the mesoporous crystalline metal oxide matrix. The mesoporous crystalline metal oxide matrix can be a mesoporous crystalline silica matrix or a mesoporous crystalline silica-aluminate matrix or a mesoporous crystalline zeolite matrix.

In a further aspect, the present invention is directed to a fuel cell comprising an inorganic proton conducting electrolyte described herein.

In still another aspect, the present invention is directed to a method of manufacturing an inorganic proton conducting electrolyte described herein, wherein the method comprises:
providing a sol comprising a heteropolyacid, at least one organometallic precursor and a surfactant;
aging the sol to obtain a gel; and
calcining the mixture.

In still another aspect, the present invention is directed to a method of manufacturing an inorganic proton conducting electrolyte described herein, wherein the method comprises:
providing a mesoporous crystalline metal oxide matrix; and
impregnating the mesoporous crystalline metal oxide matrix with a heteropolyacid.

In another aspect, the present invention is directed to an inorganic proton conducting electrolyte comprising a mesoporous crystalline metal oxide matrix and a heteropolyacid bound within the mesoporous crystalline matrix; wherein the inorganic proton conducting electrolyte is obtained by a method described herein.

### BRIEF DESCRIPTION OF THE DRAWINGS

The invention will be better understood with reference to the detailed description when considered in conjunction with the non-limiting examples and the accompanying drawings, in which:

FIG. 1 displays high resolution TEM images of the mesoporous HPW/silica inorganic electrolyte composite with various HPW contents from 10 wt % to 35 wt % (FIG. 1a: 10 wt %, FIG. 1b: 15 wt %, FIG. 1c 25 wt %, FIG. 1d 35 wt %). Scale bar=20 nm.

FIG. 2 shows small-angle XRD (SAXRD) patterns of the mesoporous HPW/silica composite with various HPW contents, namely 10 wt %, 20 wt %, 25 wt % and 35 wt %.

FIG. 3 illustrates the pore size distribution calculated from the adsorption data using the BJH model. The inset in FIG. 3 shows N₂ adsorption-desorption isotherms of mesoporous HPW/SiO₂ composites (amount of N₂ adsorbed/ml*g⁻¹ vs. relative pressure P/P₀)).

FIG. 4 shows the results of experiments in which the ionic exchange capacity (IEC in meq/g) of mesoporous HPW/SiO₂ inorganic electrolyte membranes with various HPW content has been tested in comparison with a HPW/SiO₂ composite obtained by direct mixing and sintering of 25 wt % HPW and 75 wt % SiO₂. (A) 15 wt % HPW, (B) 20 wt % HPW, (C) 25 wt % HPW and (D) 35 wt % HPW. A traditional sol-gel derived HPW/silica (25 wt %/75% wt %) is shown in (E).

FIG. 5 shows proton conductivity plots of mesoporous crystalline HPW/silica nanocomposite membranes at different temperatures (25, 50, 75, 100, 125, 150, 200, 250, 300 and 350° C.). For the temperature at 25˜100° C., the membrane is humidified by 100 RH % gas; for the temperature of 125˜350° C., the membrane is measured under humidification with gas at 100° C. The RH for the membrane, measured at temperatures of 125˜350° C. thus decreases with the increase in temperature. HPA1: 10 wt % HPW and 85 wt % SiO₂; HPA2: 20 wt % HPW and 80 wt % SiO₂; HPA3: 25 wt % HPW and 75 wt % SiO₂.

FIG. 6 illustrates the proposed formation of a mesoporous HPW/SiO₂ inorganic electrolyte. In FIG. 6, (a) shows the SEM micrograph of the surface of the self-assembled HPW/meso-silica electrolyte membrane and (b) the corresponding EDAX mapping of W.

FIG. 7 shows Arrheius plots of the proton conductivity of the electrolyte self-assembled HPW/silica mesoporous electrolyte membrane ( [symbol] ), mixed HPW/silica mesoporous electrolyte membrane ( [symbol] ) and pure mesoporous silica membrane (*) under saturated condition.

FIG. 8 illustrates the proposed proton transportation pathways of a self-assembled HPW/meso-silica electrolyte membrane (a) and a mixed HPW/meso-silica composite electrolyte membrane (b).

FIG. 9 shows the FT-IR spectra of a HPA/silica electrolyte heat-treated at various temperatures (450, 550, 650 and 750° C.).

FIG. 10 shows a SAXS spectrum, TEM micrograph and the diffraction patterns of an HPA/silica electrolyte heated-treated at various temperatures (450, 550 and 650° C.). TEM micrograph images which are shown on the right side of the graph in FIG. 10 demonstrate the structure stability of the HPA/silica structures examined.

FIG. 11 shows HPW/mesoporous silica electrolytes with crystalline structures of p6 mm, im3m, fm3m and ia3d.

FIG. 12 shows SAXS spectrum and N₂ adsorption/desorption isotherms of the HPA/silica with different crystalline structures as shown in FIG. 11.

FIG. 13 displays different mesostructural crystalline morphologies of HPW/silica electrolytes with different mesostructures, namely p6 mm, im3m, fm3m, ia3d and lamellar.

FIG. 14 displays nanochannels in different mesoporous crystalline structures of a HPW/silica mesoporous electrolyte.

FIG. 15 shows the results of an experiment in which the conductivity of HPW/silica (25 wt %/75 wt %) inorganic electrolytes with different mesoporous structures has been examined at different temperatures.

FIG. 16 shows the results of an experiment in which the conductivity of mesoporous HPW/silica electrolyte with weight ratio of 5 wt % HPW/95 wt % silica electrolyte was measured at different temperatures. For the conductivity measured at 40, 80 and 100° C., the relative humidity was 100%, while for the conductivity measured at 130° C., the humidity was controlled at 100% at 80° C.; this corresponds to a RH of 18% at 130° C.

FIG. 17 shows the results of an experiment in which the conductivity of mesoporous HPW/silica electrolyte with weight ratio of 25 wt % HPW/75 wt % silica electrolyte was measured at different temperatures. For the conductivity measured at 40, 80 and 100° C., the relative humidity was 100%, while for the conductivity measured at 130° C., the humidity was controlled at 100% at 80° C.; this corresponds to a RH of 18% at 130° C.

FIG. 18 shows a schematic diagram of the manufacturing process of a metal-supported HPW/silica mesoporous electrolyte based PEM fuel cells according to one embodiment.

FIG. 19 shows polarization and performance curves of a cell based on a 25 wt % HPW/meso-SiO₂ inorganic membrane, measured at different temperatures in 1 M methanol fuel. Anode: PtRu/C and cathode: Pt/C. For the performance measured at 25° C. and 80° C., the relative humidity was 100%, while for the performance measured at 130° C., the humidity was controlled at 100% at 80° C.; this corresponds to a RH of 18% at 130° C.

FIG. 20 shows the performance and stability of single cells assembled by 25 wt % HPW-SiO₂ nanocomposite electrolyte membrane, 1.0 mg/cm² Pt black as the anode and cathode. Oxygen was used as oxidant. Stability was measured under a constant current of 300 mA/cm². At 80° C., the cell performance for direct alcohols is very low, particularly for direct ethanol. As the temperature is raised to 300° C., the maximum power density increases to about 112 mW/cm² for direct ethanol and 128.5 mW/cm² for direct methanol that is 6.6 and 3 times higher than that at 80° C. The cell performance is stable for direct alcohol fuels (FIG. 20b) and no sharp drop in the cell voltage as commonly observed for the direct alcohol fuel cells at low temperatures. This indicates the elimination or negligible poisoning effect of the alcohol reaction on the Pt black catalysts.

FIG. 21 shows the performance of a PEM single cell assembled by 25 wt % HPW-SiO₂ nanocomposite electrolyte membrane, 0.4 mg/cm² Pt black as the anode and cathode, measured at 80° C. The cell performance with Pt black anode and cathode achieved a maximum power density of about 162 mW/cm² at 80° C.

FIG. 22 shows the Keggin structure for the heteropolyacid phosphotungstic acid (H₃PW₁₂O₄₀, abbreviated as HPW or PWA). Three types of exterior oxygen atoms are shown: O_{b}, O_{c} and O_{d} in the Keggin unit. Oₐ is the central oxygen atom.

FIG. 23 shows the schematic diagram of the setup for the conductivity measurement of HPW/silica membrane using four-probe technique under controlled humidity.

FIG. 24 illustrates the proposed formation of a mesoporous HPW/SiO₂ inorganic electrolyte, using a vacuum-assisted impregnation method (VIM).

FIG. 25 shows the performance of a PEM single cell assembled by 75 wt % HPW-SiO₂ nanocomposite electrolyte membrane, 0.5 mg/cm² Pt black as the anode and cathode, measured at 50° C. The cell performance with Pt black anode and cathode achieved a maximum power density of about 130 mW/cm² at 50° C. The 75 wt % HPW-SiO₂ nanocomposite electrolyte membrane was prepared by a vacuum-assisted impregnation method (VIM).

FIG. 26 shows optical micrographs of (a) 25 wt % HPW/75 wt % silica electrolyte membrane prepared by hot-press; and (b) a MEA consisted of a 25 wt % HPW/75 wt % silica electrolyte membrane and Pt anode and cathode.

FIG. 27 shows a scanning electron microscopy (SEM) micrograph of a porous NI mesh used for the fabrication of metal-supported HPW/silica nanocomposite electrolyte membrane.

### DETAILED DESCRIPTION OF THE INVENTION

In a first embodiment, the present invention is directed to an inorganic proton conducting electrolyte consisting of a mesoporous crystalline metal oxide matrix and a heteropolyacid bound within the mesoporous crystalline metal oxide matrix. In one embodiment, the mesoporous crystalline metal oxide matrix can be a mesoporous crystalline silica matrix or a mesoporous crystalline silica-aluminate matrix or a mesoporous crystalline zeolite matrix.

A matrix as used herein is “crystalline”. Crystalline means that the constituent atoms, molecules, or ions of the material are arranged in an orderly repeating pattern, i.e. in a crystal lattice, extending in all three spatial dimensions. According to the common knowledge, a crystalline structure does not include an amorphous structure which is characterized by the absence of a crystal lattice but is arranged in a disordered manner. An amorphous structure is isotropic because it does not comprise a physically distinct orientation. Amorphous structures are for example obtained by classical sol-gel methods or sol-gel-hydrothermal methods which do not use supramolecules, such as surfactants or biomacromolecules as templates for the manufacture of the metal matrix as will be described further below. Thus, the mesoporous crystalline matrix is non-amorphous and consists of a regular or ordered structure, i.e. a crystalline structure.

These crystalline matrix structures are mesoporous or in other words comprise a mesostructure. Such mesostructures can include two dimensional or three dimensional mesostructures. Examples for such mesostructures include, but are not limited to two dimensional (2D) and three dimensional (3D) crystal space groups. Examples for 2D space groups include, but are not limited to a hexagonal, space group p6 mm. Examples for a 3D space group include, but are not limited to P63/mmc, Pm3m, Pm3n, Fd3m, Fm3m; Im3m; or Ia3d; or mixtures of 2D and 3D structures.

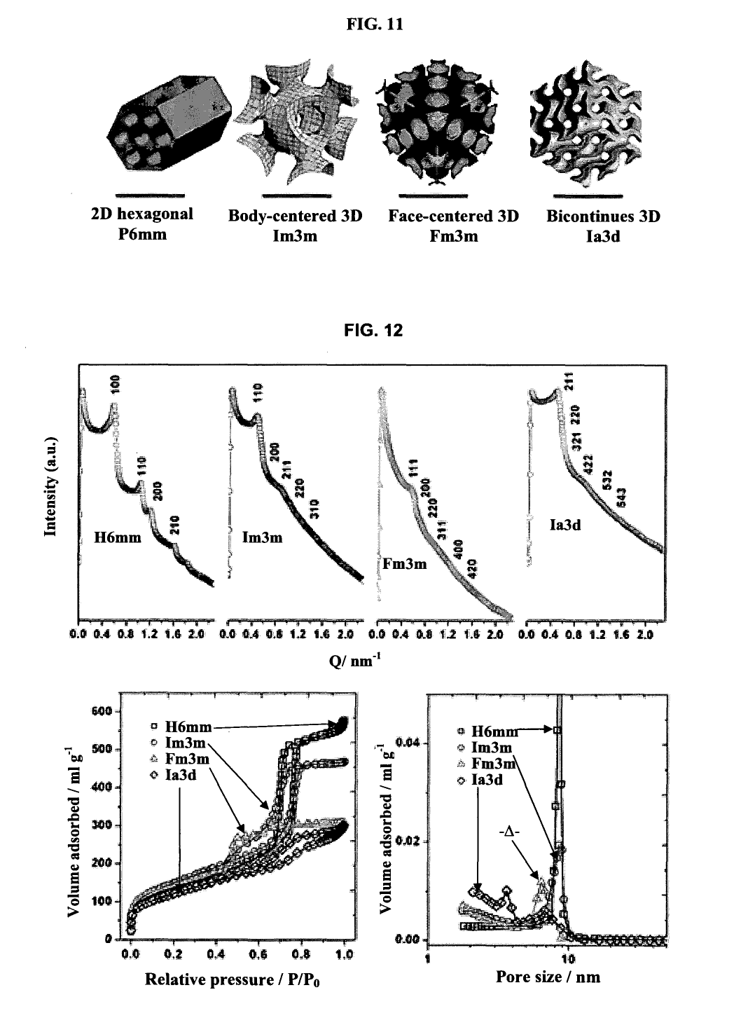

With “mesoporous” structure it is meant that the crystalline metal oxide matrix comprises a mesostructure with pores and channels, i.e. the matrix comprises nanopores and nanochannels in the mesoporous range. According to IUPAC definition “meso” refers to dimensions between about 2 nm to about 50 nm. Exemplary illustrations of crystalline matrices with a mesoporous structure are illustrated, e.g., in FIGS. 11, 13 and 14.

With “inorganic” proton conducting electrolyte it is meant that the electrolyte as such does not include any organic or polymeric materials. With “polymeric” it is meant a molecule that consists of sufficient number of repeating structural units which are bound together via covalent chemical bonds. With “organic” it is referred to any member of a large class of chemical compounds whose molecules contain carbon.

In this inorganic electrolyte the heteropolyacid is anchored inside the pores and channels of the mesoporous crystalline metal oxide matrix. The heteropolyacid contains negative charges which are neutralized in the acid form by three protons in the form of acidic hydroxyl groups at the exterior of the mesoporous structure. As a result, the heteropolyacid has not only a high conductivity to proton, but also exhibits negative charges in the presence of water. Thus, the heteropolyacid binds in the mesoporous structure of the matrix via electrostatic attractive forces.

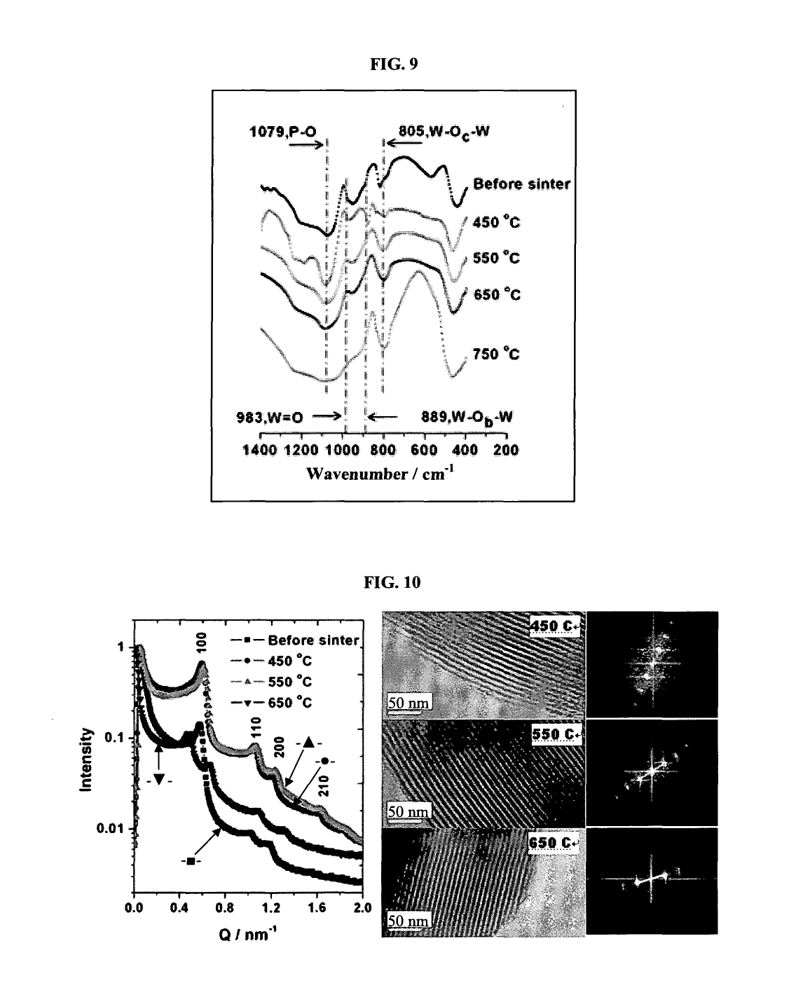

Thus, it has been shown for the first time that a mesoporous crystalline metal oxide matrix which binds a heteropolyacid in its mesopores can be used as electrolyte. Such an electrolyte is particularly advantages for the application in fuel cells operating at high temperatures because of the thermal stability of the electrolyte. The structure of the inorganic electrolyte is stable at temperatures up to 650° C. as can be seen from FIG. 9 and is functional at temperatures up to 600° C. With “functional” it is meant that the electrolyte can operate at temperatures up to 600° C.

The inorganic electrolyte is an ion-conducting material which transports the ion (i.e. the charge carrier) from the anode to the cathode of a fuel cell. In case the fuel is hydrogen, the ion is a hydrogen ion, which is simply a single proton. Accordingly, electrolytes of fuel cells conduction a proton are called proton-conducting electrolytes.

As already mentioned, according to IUPAC definition mesopores are pores with a pore size between about 2 to 50 nm. In one embodiment, the pore size is between about 2 to 20 nm, or 2 to 10 nm, or 2 to 5 nm, or 2 to 4 nm, or 2 to 3 nm, or 3 to 6 nm, or 3 to 4 nm or 3 to 10 nm. However, the mesoporous crystalline metal oxide matrix also includes nanochannels. “Nano” means that at least one dimension of the channels is in the nanometer range. The at least one dimension of the nanochannels in the mesoporous crystalline metal oxide matrix of the electrolyte in the nanometer range are within the meso-range, i.e. having a maximal dimension of between about 2 to 50 nm. In one embodiment, the at least one dimension of the measurement of the nanochannels is conform to the size of the mesopores and thus lies within the ranges indicated further above.

The thickness of the walls forming the mesostructure of the electrolyte is between about 4 to 20 nm, or between about 4 to 10 nm, or between about 4 to 8 nm, or between about 3 to 5 nm, or about 2, 3, 4, 5, 6, 7, 8, 9, 10 nm or 15 nm.

The inorganic proton conducting electrolyte comprises a heteropolyacid. Heteropolyacids are known in the art to be usable as catalyst materials for chemical reactions, such as for the catalytic oxidation of organosulfur compounds in fuel oil (Yan, X.-M., et al., 2007, Materials Research Bulletin, vol. 42, pp. 1905). The heteropolyacids can be based on any of the following structures, which include, but are not limited to the Keggin structure (XM₁₂O₄₀ⁿ⁻, X=one of Si, P, As, Ge or S; M=one of W, Mo or V), the Silverton structure (e.g., (NH₄)₂H₆[XMo₁₂O₄₂], X=one of Ce⁴⁺, Th⁴⁺, Np⁴⁺, U⁴⁺), the Dawson structure (X₂M₁₈O₆₂ⁿ⁻, X=one of Si, P, S, As or Ge; M=one of W, Mo or V), the Waugh structure (e.g., (NH₄)₆[XMo₉O₃₂], X=one of Ni⁴⁺ or Mn⁴⁺) or the Anderson structure ((NH₄)₆[XMO₆O₂₄], X=one of Te, Ni, Cr, Mn, Ga, Co, Al, Rh, Fe, to name only a few). It is also possible that mixtures of heterpolyacids with different structures are bound within the mesoporous crystalline matrix of the electrolyte. FIG. 22 shows an illustrative 3D model of the Keggin structure of a heteropolyacid which has been used in one embodiment.

Such a heteropolyacid can have the general formula (I):

H₃MX₁₂O₄₀ (I);

wherein
M is the central atom which is either P or Si or As or Ge; and
X is the heteroatom which is either V or W or Mo. In one example, phosphotungstic acid (H₃PW₁₂O₄₀, abbreviated as HPW or PWA) has been used. In one embodiment, the heteropolyacid adopts the Keggin structure.

In another embodiment, the heteropolyacid has the general formula (II):

CS_{z}H_{3-z}MX₁₂O₄₀ (II);

wherein
M is the central atom which is either P or Si or Ge or As;
X is the heteroatom which is either V or W or Mo; and
z is 0≦z≦3. In one embodiment, the heteropolyacid adopts the Keggin structure.

The mesoporous crystalline metal oxide matrix can include, but is not limited to a mesoporous crystalline silica matrix or a mesoporous crystalline silica-aluminate matrix or a mesoporous crystalline zeolite matrix. A mesoporous crystalline silica-aluminate matrix differs from a mesoporous crystalline silica oxide matrix only insofar that a portion of the silica oxide present in the silica oxide matrix is replaced by aluminium oxide. Such silica-aluminate matrix can be obtained by using at least two different organometallic precursors in the method of manufacturing the crystalline matrix, namely one for SiO₂ and one for Al₂O₃. Thus, such a matrix is consists of two different metal oxides, silica oxide and aluminium oxide. A metal oxide matrix named silicon oxide matrix and silica matrix are metal oxide matrices comprising the same structure. In this structure a covalent bond exists between SiO₂, forming chain or ring or network or three dimensional structures like O—Si—O—Si—O—Si—O In general, silica exists in crystalline silica and amorphous silica (the latter one being excluded herein). Crystalline silica exists in several different polymorphic forms corresponding to different ways of combing tetrahedral groups with all corners shared. Three basic structures—quartz, tridymite, cristobatite—each exist in two or three modifications. Some silicate structures are chain structures but many important silicate structures are based on an infinite three-dimensional silica framework. Among these are the crystalline feldspars and crystalline zeolites which also form embodiments of the present invention. The feldspars are characterized by a framework formed with Al³⁺ replacing some of Si⁴⁺ to make framework with a net negative charge that is balanced by large ions in interstitial positions, e.g. Albite (NaAlSi₃O₈), anorthite (CaAl₂Si₂O₈), celsian (BaAl₂Si₂O₈), and the like.

A zeolite is characterized by an aluminosilicate tetrahedral framework, ion-exchangeable large cations, and loosely held water molecules permitting reversible dehydration. The general formula can be expressed as X_{y}^{1+,2+}, Alₓ³⁺Si₁₋ₓ⁴⁺O₂.nH₂O, Since the oxygen atoms in the framework are each shared by two tetrahedrons, the (Si,Al):O₂.nH₂O ratio is exactly 1:2. The amount of large cations (X) present is conditioned by the Al:Si ratio and the formal charge of these large cations. Typical large cations that can be used are the alkalies and alkaline earths, such as Na⁺, K⁺, Ca²⁺, Sr²⁺ or Ba²⁺. The large cations, coordinated by framework oxygens and water molecules, reside in large cavities in the crystal structure; these cavities and channels can permit the passage of molecules, such as heteropolyacids.

Important structural features of zeolites described herein include loops of 4-, 5-, 6-, 8-, and 12-membered tetrahedral rings which can further link to form channels and cages. Zeolites can be classified according to groups and include the following groups which can be used herein: analcime, sodalite, chabazite, natrolite, phillipsite and mordenite. Examples of zeolites from such groups include, but are not limited to chabazite Ca₂(Al₄Si₈O₂₄).13H₂O, eroionite Ca_{4.5}(Al₉Si₂₇O₇₂).27H₂O, mordenite Na(AlSi₅O₁₂).3H₂O, chinoptilolite, faujasite (Na₂,Ca)₃₀((Al,Si)₁₉₂O₃₈₄).260H₂O, phillipsite (K,Na)₅(Al₅Si₁₁O₃₂). 10H₂O, zeolite A Na₁₂Al₁₂Si₁₂O₄₈, zeolite L K₆Na₃Al₉Si₂₇O₇₂.21H₂O, Zeolite Y, zeolite X Na₂₀—Al₂O₃-2.5SiO₂ or ZSM-5 NaₙAlₙSi₉₆₋ₙO₁₉₂.16H₂O (0<n<27).

A metal oxide matrix can be made of a metal which can include, but is not limited to silicon, titanium, phosphor, antimony, cobalt, iron, manganese, silver, copper, potassium, rubidium, thallium, sodium, aluminium, barium, calcium, beryllium, magnesium, nickel, palladium, strontium, tin, vanadium, zinc, boron, chromium, gallium, indium, tungsten, yttrium, cerium, germanium, ruthenium, selenium, tellurium, tantalum, niobium, rhenium, praseodymium, neodymium, samarium, europieum, holmium, thorium, uranium, barium, plutonium, neptunium, lanthanum, strontium or molybdenum.

A metal oxide can include, but is not limited to silicon dioxide (SiO₂), titanium dioxide (TiO₂), antimony tetroxide (Sb₂O₄), cobalt(II,III) oxide (CO₃O₄), iron(II,III) oxide (Fe₃O₄), manganese(II,III) oxide (Mn₃O₄), silver(I,III) oxide (AgO), copper(I) oxide (Cu₂O), potassium oxide (K₂O), rubidium oxide (Rb₂O), silver(I) oxide (Ag₂O), thallium oxide (Tl₂O), aluminium monoxide (A10), barium oxide (BaO), beryllium oxide (BeO), calcium oxide (CaO), cobalt(II) oxide (CoO), copper(II) oxide (CuO), iron(II) oxide (FeO), magnesium oxide (MgO), nickel(II) oxide (NiO), palladium(II) oxide (PdO), strontium oxide (SrO), tin(II) oxide (SnO), titanium(II) oxide (TiO), vanadium(II) oxide (VO), zinc oxide (ZnO), aluminium oxide (Al₂O₃), antimony trioxide (Sb₂O₃), phosphorus trioxide (P₄O₆), phosphorous pentoxide (P₂O₅), rhenium trioxide (ReO₃), rhenium(VII) oxide (Re₂O₇), praseodymium(IV) oxide), (PrO₂), dipraseodymium trioxide (Pr₂O₃), neodynum oxide (Nd₂O₃), samarium(III) oxide (Sm₂O₃), europieum oxide, holmium(III) oxide (Ho₂O₃), thorium dioxide (ThO₂), uranium dioxide (UO₂), uranium trioxide (UO₃), barium oxide (BaO), plutonium dioxide (PuO₂), neptunium dioxide (NpO₂), lanthanum(III) oxide (La₂O₃), strontium oxide (SrO),boron oxide (B₂O₃), chromium(III) oxide (Cr₂O₃), gallium(III) oxide (Ga₂O₃), indium(III) oxide (In₂O₃), iron(III) oxide (Fe₂O₃), nickel(III) oxide (Ni₂O₃), thallium(III) oxide (Tl₂O₃), titanium(III) oxide (Ti₂O₃), tungsten(III) oxide (W₂O₃), vanadium(III) oxide (V₂O₃), yttrium(III) oxide (Y₂O₃), cerium(IV) oxide (CeO₂), chromium(IV) oxide (CrO₂), germanium dioxide (GeO₂), manganese(IV) oxide (MnO₂), ruthenium(IV) oxide (RuO₂), selenium dioxide (SeO₂), tellurium dioxide (TeO₂), tin dioxide (SnO₂), tungsten(IV) oxide (WO₂), vanadium(IV) oxide (VO₂), zirconium dioxide (ZrO₂), antimony pentoxide (Sb₂O₅), niobium pentoxide, tantalum pentoxide (Ta₂O₅), vanadium(V) oxide (V₂O₅), chromium trioxide (CrO₃), molybdenum(VI) oxide (MoO₃), selenium trioxide (SeO₃), tellurium trioxide (TeO₃), tungsten trioxide (WO₃), manganese(VII) oxide (Mn₂O₇), osmium tetroxide (OsO₄), or ruthenium tetroxide (RuO₄). As mentioned above, in one embodiment, it is referred to a silica matrix, i.e. a metal oxide matrix made with SiO₂. It is also possible to obtain metal oxide matrices comprising different mixtures of metal oxides. Examples for such crystalline matrices are crystalline silica-aluminate matrices or crystalline feldspar or crystalline zeolite matrices.

The inorganic proton conducting electrolyte referred to herein can comprise between about 60 to 95% of the mesoporous crystalline metal oxide matrix and between about 5 to 40% of the heteropolyacid based on the total weight of the electrolyte. Some examples, referred to herein comprise between about 25% of the heteropolyacid and 75% of the mesoporous crystalline metal oxide matrix, or between about 15% of the heteropolyacid and 85% of the mesoporous crystalline metal oxide matrix, or between about 20% of the heteropolyacid and 80% of the mesoporous crystalline metal oxide matrix, or between about 30% of the heteropolyacid and 70% of the mesoporous crystalline metal oxide matrix, between about 35% of the heteropolyacid and 65% of the mesoporous crystalline metal oxide matrix, or between about 40% of the heteropolyacid and 60% of the mesoporous crystalline metal oxide matrix, or between about 5% of the heteropolyacid and 95% of the mesoporous crystalline metal oxide matrix, or in a mesoporous crystalline metal oxide matrix with a content of heteropolyacid of more than 5 wt %.

The manufacture of mesoporous crystalline metal oxide matrices, such as mesoporous crystalline matrices made of the aforementioned materials is known in the art (see e.g., Wan, Y., Zhao, D., 2007, Chem. Rev., vol. 107, no.7, pp. 2821). Highly ordered mesoporous metal oxide matrices can be obtained from the organic-inorganic self-assembly of the matrices using supramolecules, such as surfactants or biomacromolecules as templates. The organic-inorganic self assembly is driven by weak noncovalent bonds, such as hydrogen bonds, van der Walls forces and electrovalent bonds between the supramolecule, such as surfactants and inorganic species. After removal of the template an ordered mesoporous crystalline matrix is obtained.

Using a template based method for the synthesis of such ordered crystalline metal oxide matrices results in matrices with different mesostructures. As mentioned above, such mesostructures can include two dimensional or three dimensional mesostructures. Examples for such structures include, but are not limited to two dimensional (2D) hexagonal, space group p6 mm, three dimensional (3D) hexagonal P63/mmc, 3D cubic Pm3m, Pm3n, Fd3m, Fm3m; body centered Im3m; or bicontinuous cubic Ia3d; or mixtures of 2D and 3D structures, to name only a few.

Methods that can be used to obtain such ordered crystalline metal oxide matrices include, but are not limited to a sol-gel method or a sol-gel-hydrothermal method. As indicated already by its name a sol-gel-hydrothermal method includes a sol-gel method. In general, a “sol” is a dispersion of solid particles in a liquid where only the Brownian motions suspend the particles (herein the metal precursor). A “gel” is a state where both liquid and solid are dispersed in each other, which presents a solid network containing liquid components. In general, the sol-gel method is based on the phase transformation of a sol obtained from metallic alkoxides or organometallic precursors. The sol, which is a solution containing particles in suspension, is polymerized at low temperature to form a wet gel. The wet gel is going to be densified through a thermal annealing. In general, the sol-gel process consists of hydrolysis and condensation reactions, which lead to the formation of the sol.

Therefore, in one embodiment, the present invention is directed to a method of manufacturing an inorganic proton conducting electrolyte. The method comprises:
providing a sol comprising a heteropolyacid, at least one organometallic precursor and a surfactant;
aging the sol to obtain a gel; and
calcining the mixture.

The addition of a surfactant results in the formation of a two and/or three dimensional structure with a well ordered mesostructure which serves as fixed binding places for the heteropolyacid immobilized in this two and/or three-dimensional matrix. The mesoporous structure thus formed in the mesoporous crystalline metal oxide matrix having the heteropolyacid bound therein form continues proton transportation pathways that facilitate proton transportation through the electrolyte.

In contrast, a sol-gel method or a sol-gel-hydrothermal method not using a template (such as a surfactant) results in amorphous structures with a random porous structure with pore sizes from nm to microns. Furthermore, in amorphous structures the distribution of heteropolyacids is random and limited to the surface of the amorphous matrix. The conductivity of such synthesized heteropolyacid/matrix is initially high but is not stable due to the inevitable leaching of the heteropolyacid out of the amorphous matrix.

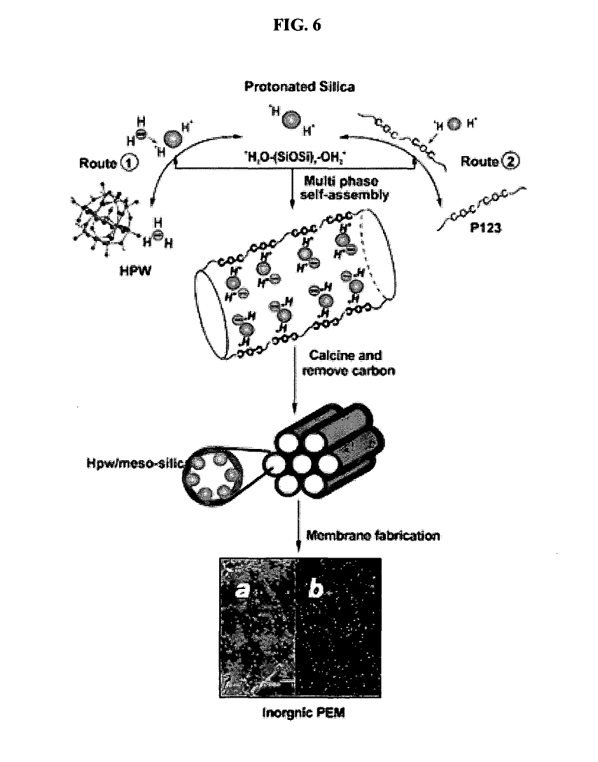

Without being bound by theory, the inventors suggest that the reaction mechanism illustrated in FIG. 6 describes the reactions occurring when carrying out the method as described above. The illustrated example in FIG. 6 shows the mechanism underlying the manufacturing process which results in a mesoporous silica matrix with a heteropolyacid (HPA), namely 12-phosphotungstic acid (HPW) immobilized in the mesoporous silica matrix (i.e. the exemplary manufacture of a HPW/silica mesoporous inorganic electrolyte).

There are two self-assembly steps (route 1 and 2) occurring during the formation of an ordered mesoporous HPW/silica nanocomposite structure. The first is the self-assembly of HPW-silica-HPW chain structures through electrostatic force between negatively charged HPW molecules and positively charged silica species. The HPW Keggin unit contains negative charges which are neutralized in the acid form by three protons in the form of acidic hydroxyl groups at the exterior of the structure.

As a result, HPW not only have high conductivity to proton, but also exhibit negative charges in the presence of water. On the other hand, the silica oxide molecules in water in the presence of high acidity are positively charged. Under normal pH range, the proton adsorption on SiOH surface groups is very low. The presence of high acidity HPW molecules will significantly increase the proton adsorption reaction of SiOH, leading to the rapid increase in zeta potential and forming positively charged SiOH₂⁺ external groups.

As a result, self-assembly would occur between the positively charged silica species and the negatively charged HPW by the electrostatic force. With the addition of a structure-directing agent, in this case a surfactant, namely P123, the tube-cumulated mesoporous HPW-SiO₂ with the template of P123 surfactant is formed through cooperative hydrogen bonding self-assembly between the organic HPW-silica chain precursors and inorganic triblock copolymer P123 surfactant. With the phase separation of P123, the colloidal complex finally forms an ordered HPW/SiO₂ framework. During solvent evaporation, the mesostructure becomes highly ordered.

The template can then be removed by heat treatment, with the HPW molecules anchored into SiO₂ crystal structures in the walls of the mesoporous framework.

HPA/metal mesoporous electrolytes can, for example, be hot-pressed to form a solid proton exchange membrane after having been mixed with a high-temperature thermoplastic polyimide powder or polyvinylpyrrolidone (PVP) or Polyvinylidene Fluoride (PVDF) as binder.

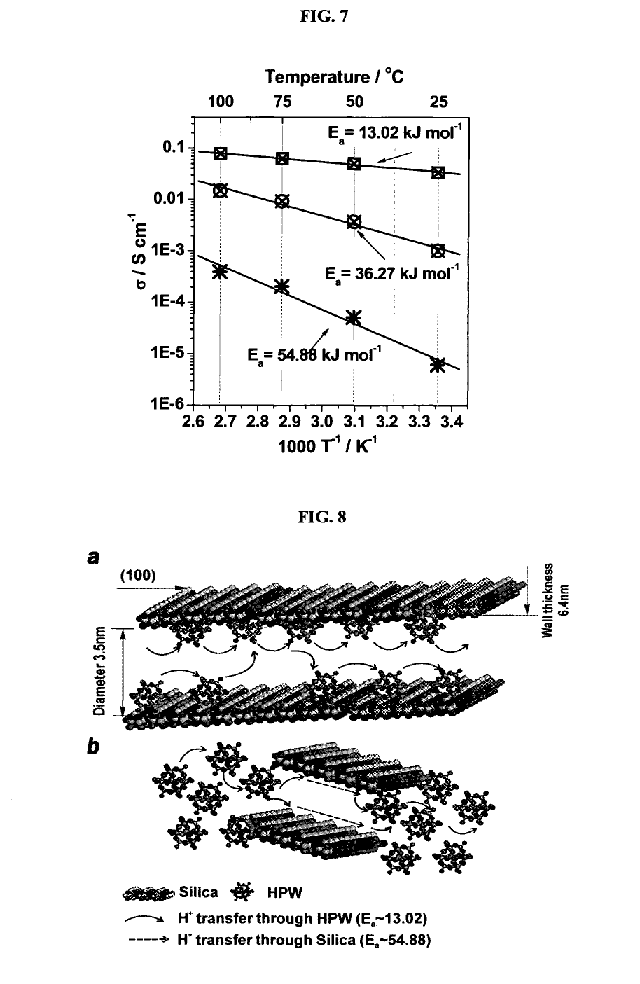

The proton transportation mechanism of such HPA/metal mesoporous electrolytes was studied based on a HPW/silica mesoporous proton exchange membrane using self-assembled inorganic electrolyte with 25 wt % HPW as an example. The proton conductivity of the self-assembled HPW/meso-silica electrolyte was measured by electrochemical impedance spectroscopy at different temperatures. The impedance responses are similar to that of a Nafion® membrane and can be characterized by typical Cole-Cole plots. The conductivity data are shown in FIG. 7. For the purpose of comparison, the proton conductivity of pure mesoporous silica and direct mixed 25 wt. % HPW/meso-silica is also shown in FIG. 7. The self-assembled HPW/silica mesoporous electrolyte has a much higher proton conductivity as compared with mixed HPW/meso-silica and pure mesoporous silica. Nevertheless, also a mesoporous metal matrix which was mixed only after its manufacture with a heteropolyacid can be used as electrolyte, for example in high temperature fuel cell applications.

The proton conductivity of self-assembled HPW/silica mesoporous electrolyte is 0.06 Scm⁻¹ at 75° C. and 100% RH, which is significantly higher than 0.015 Scm⁻¹ of the mixed HPW/meso-silica composite and 2×10⁴ Scm⁻¹ of the pure mesoporous silica under the same testing conditions. Proton transportation through the pure mesoporous silica is drastically limited.

The activation energy (Eₐ) was calculated by linear regression of the Arrhenius plots of FIG. 7. For the proton conduction on the self-assembled HPW/silica mesoporous electrolyte, Eₐ is 13.02 kJmol⁻¹, very close to the activation energy of ˜11 kJmol⁻¹ reported for the pure HPW molecules under the saturated condition. The low activation energy, together with the high conductivity of the self-assembled HPW/silica mesoporous composite, suggests a continuous proton transport pathway through the Keggin-type HPW molecules in the self-assembled HPW/meso-silica electrolyte.

The proton transportation in pure mesoporous silica presents a different behaviour with a much higher activation energy of 54.88 kJmol⁻¹. With a possible cooperative mechanism, proton transfer occurs along the linked chain of hydrogen bonds, which involves the dissociation of protons, and the orientation of the hydrogen bonds along the conducting direction. The formation of strong silanol bond weakens the hydrogen bond, and results in a very low proton conductance. The activation energy of the mixed HPW/silica mesoporous composite is 36.27 kJmol⁻¹, significantly higher than that of the self-assembled HPW/silica mesoporous composite but lower than that of the pure mesoporous silica. This indicates that the proton mobility through the proton hopping HPW molecules may be hampered by the low conductance silica region because of the close-packed HPW/silica structure and the subsequent low proton transportation pathway through mesoporous silica.

FIG. 8 shows the proposed proton transportation mechanism of the ordered mesoporous arrays with trapped HPW inside or on the walls of the mesopores of the mesoporous silica structure. The effective proton transport pathways through the trapped HPW in the mesoporous channels are supported by the high proton conductivities and low activation energy. The similar activation energies of the proton conduction through the self-assembled HPW/meso-silica inorganic electrolyte and the perfluorosulfonc acid membranes such as Nafion® show that the proton-transporting mechanism through the self-assembled HPW/meso-silica electrolyte is probably predominated by a Grotthus mechanism which require an activation energy ranging from 10-40 kJmol⁻¹, and assisted by a vehicular mechanism. In this case, the proton transportation occurs through protonated HPW molecules that act as donors and acceptors in proton-transfer reactions, and the bound water molecules that act as a vehicle and forms H₃O⁺ clusters that facilitate the proton transport through the Grotthuss mechanism and generate continuous proton conductive pathway.

On the other hand, the mixed HPW/meso-silica composite could be represented by the close packed clusters HPW and mesoporous silica. The existence of separated HPW clusters is also supported by the lower stability of the mixed HPW/meso-silica composite. Thus, the proton transportation could occur through the individual HPW clusters and meso-silica clusters via the hydroxyl groups bonded to silanol. Such proton conduction through separated HPW clusters and mesoporous silica appears to be supported by a lower proton conductivity and higher activation energy for the proton conductivity of the mixed HPW/meso-silica composite.

The mesostructure of the matrix can be adapted depending on the surfactant and concentration ratio of surfactant to organometallic precursor that is used in the sol-gel method or sol-gel-hydrothermal method. In general, a surfactant results in a highly ordered and more stable crystalline structure of the mesoporous matrix in which the heteropolyacid is bound as described above. Examples for different three-dimensional mesoporous structures which can be obtained with different surfactants are illustrated in FIG. 11.

A “surfactant” as used herein is a member of the class of materials that, in small quantity, markedly affect the surface characteristics of a system; also known as surface-active agent. In a two-phase system, for example, liquid-liquid or solid-liquid, a surfactant tends to locate at the interface of the two phases, where it introduces a degree of continuity between the two different materials. For the manufacture of the inorganic mesoporous electrolyte described herein the surfactant serves as structure directing agent, i.e. structure directing surfactant. Addition of a structure directing surfactant during the manufacture of the inorganic electrolyte results in a tube-cumulated mesoporous heteropolyacid-matrix which is formed through cooperative hydrogen bonding self-assembly between the heteropolyacid-organometallic (chain) precursor and inorganic surfactant.

In general, surfactants that can be used herein are divided into four classes: amphoteric surfactants, with zwitterionic head groups; anionic surfactants, with negatively charged head groups; cationic surfactants, with positively charged head groups; and non-ionic surfactants, with uncharged hydrophilic head groups.

Each of them can be used independently in the methods described herein or mixtures of different surfactants can be used.

Examples of groups of anionic salt surfactants that can be used, include but are not limited to carboxylates, sulfates, sulfonates, phosphates, to name only a few. Also, anionic surfactant terminal carboxylic acids (salts) can be used to template the synthesis of mesoporous silica matrices with the assistance of aminosilanes or quaternary aminosilanes such as 3-aminopropyltrimethoxysilane (APS) and N-trimethoxylsilylpropyl-N,N,N-trimethylammonium chloride (TMAPS) as co-structure directing agents.

Illustrative examples of an anionic surfactant include, but are not limited to sodium dodecyl sulfate (SDS), sodium pentane sulfonate, dehydrocholic acid, glycolithocholic acid ethyl ester, ammonium lauryl sulfate and other alkyl sulfate salts, sodium laureth sulfate, alkyl benzene sulfonate, soaps, fatty acid salts or mixtures thereof.

Illustrative examples of a nonionic surfactants include, but are not limited to polyether, alkyl poly(ethylene oxide), diethylene glycol monohexyl ether, copolymers of poly(ethylene oxide) and poly(propylene oxide), hexaethylene glycol monohexadecyl ether, alkyl polyglucosides (such as octyl glucoside, decyl maltoside), digitonin, ethylene glycol monodecyl ether, cocamide MEA, cocamide DEA, cocamide TEA, fatty alcohols (such as cetyl alcohoh, oleyl alcohol), sorbitan esters (such as surfactants of the Tween® series (Tween® 20, Tween® 40, Tween® 60, Tween® 80, Tween® 85) and Span® series (Span® 20, Span® 60, Span® 80, Span® 85)), oligomeric alkyl poly(ethylene oxides) (such as surfactants of the Brij® series (Brij® 30, Brij® 35, Brij® 52, Brij® 56, Brij® 58, Brij® 72, Brij® 76, Brij® 78, Brij® 92V, Brij® 93, Brij® 96, Brij® 97, Brij® 98, Brij® 700) and Tergitol™ series (Tergitol™ NP-4, Tergitol™ NP-5, Tergitol™ NP-6, Tergitol™ NP-7, Tergitol™ NP-8, Tergitol™ NP-9, Tergitol™ NP-10, Tergitol™ NP-11, Tergitol™ NP-12, Tergitol™ NP-13, Tergitol™ NP-14, Tergitol™ NP-15, Tergitol™ NP-30, Tergitol™ NP-40, Tergitol™ NP-50, Tergitol™ NP-55, Tergitol™ NP-70)), alkyl-pheno poly(ethylene oxides) (such as surfactants of the Triton® series (Triton® X-100, Triton® N-101, Triton® X-114, Triton® X-405, Triton® SP-135, Triton® SP-190)) or mixtures thereof. In one illustrative example a nonionic poloaxamer is used, such as F127 or P123 or F108.

A suitable polyether can be a diblock (A-B) or triblock copolymer (A-B-A or A-B-C) or star diblock copolymers. The polyether may for example include one of an oligo(oxyethylene) block or segment, a poly(oxyethylene) block (or segment), an oligo(oxy-propylene) block, a poly(oxypropylene) block, an oligo(oxybutylene) block and a poly(oxybutylene) block. An example for a triblock copolymer includes, but is not limited to poly(ethylene oxide)-b-poly(propylene oxide)-b-poly(ethylene oxide. Another illustrative example of a respective triblock copolymer is a poloaxamer. A poloaxamer is a difunctional block copolymer surfactant terminating in primary hydroxy groups. It typically has a central non-polar chain, for example of polyoxypropylene (poly(propylene oxide)), flanked by two hydrophilic chains of e.g. polyoxyethylene (poly(ethylene oxide)). The polyether may thus in some embodiments be a poly(ethylene oxide)-poly(propylene oxide)-poly(ethylene oxide) (PEO-PPO-PEO) triblock copolymer. The lengths of the polymer blocks can be customized, so that a large variety of different poloxamers with slightly different properties is commercially available. For the generic term “poloxamer”, these copolymers are commonly named with the letter “P” (for poloxamer) followed by three digits, the first two digits×100 give the approximate molecular mass of the polyoxypropylene core, and the last digit×10 gives the percentage polyoxyethylene content (e.g., P407=Poloxamer with a polyoxypropylene molecular mass of 4,000 g/mol and a 70% polyoxyethylene content). For the Pluronic tradename, coding of these copolymers starts with a letter to define it's physical form at room temperature (L=liquid, P=paste, F=flake (solid)) followed by two or three digits, the first digit(s) refer to the molecular mass of the polyoxypropylene core (determined from BASF's Pluronic grid) and the last digit×10 gives the percentage polyoxyethylene content (e.g., F127=Pluronic with a polyoxypropylene molecular mass of 4,000 g/mol and a 70% polyoxyethylene content). The polyether may for example be a triblock copolymer of oxirane with 2-methyl-oxirane, having the Chemical Abstract No. 691397-13-4. Illustrative examples of such a polyether are the commercially available triblock copolymers Adeka Pluronic F 68, Nissan Plonon 104, Novanik 600/50, Lutrol 127, Pluriol PE 1600, Plonon 104, Plonon 407, Pluronic 103, Pluronic 123, Pluronic 127, Pluronic A 3, Pluronic F-127, Pluronic F 168, Pluronic 17R2, Pluronic P 38, Pluronic P 75, Pluronic PE 103, Pluronic L 45, Pluronic SF 68, Slovanik 310, Synperonic P 94 or Synperonic PE-F 127, to name only a few.

Examples for cationic surfactants include cationic quaternary ammonium surfactants which can include, but are not limited to alkyltrimethyl quaternary ammonium surfactants, gemini surfactants (e.g. Cₙ₋ₛ₋ₘ (n=8-22; s=2-6, m=1-22); Cₙ₋ₛ₋₁ (n=8-22, s=2-6); 18B₄₋₃₋₁), bolaform surfactants (Rₙ (n=4, 6, 8, 10, 12)), tri-headgroup cationic surfactants (Cₘ₋ₛ₋ₚ₋₁ (m=14, 16, 18, s=2, p=3)) or tetra-headgroup rigid bolaform surfactants (Cₙ₋ₘ₋ₘ₋ₙ (N=2, 3, 4, m=8, 10, 12)).

Illustrative examples of a cationic surfactant include, but are not limited to octadecyltrimethylammonium bromide (ODTMABr), cetyl trimethylammonium bromide (CTAB), dodecylethyldimethylammonium bromide, cetylpyridinium chloride (CPC), polyethoxylated tallow amine (POEA), hexadecyltrimethylammonium p-toluenesulfonate, benzalkonium chloride (BAC), benzethonium chloride (BZT), 3-aminopropyltrimethoxysilane (APS), N-trimethoxylsilylpropyl-N,N,N″-trimethyl-aminonium (TMAPS) or mixtures thereof.

Examples for amphoteric surfactants include, but are not limited to dodecyl betaine, sodium 2,3-dimercaptopropanesulfonate monohydrate, dodecyl dimethylamine oxide, cocamidopropyl betaine (CAPB), 3-[N,N-dimethyl(3-palmitoylaminopropyl)ammonio]-propanesulfonate, coco ampho glycinate or mixtures thereof.

The sol can be prepared by any method known in the art. In general, the order of mixing the components of the sol together is not critical for the formation of the sol and therefore mixing can be carried out in any order. In one embodiment referring to a sol-gel method using a template, the step of providing a sol comprising a heteropolyacid, an organometallic precursor and a surfactant comprises:
providing a first solution comprising a heteropolyacid and at least one organometallic precursor;
adding the first solution into a second solution comprising a surfactant to obtain a sol.

The components of the sol can be dissolved before mixing in a suitable solvent. In general, in a sol-gel method or a sol-gel-hydrothermal method the single components can be dissolved in an alcohol. Examples of such alcohols include, but are not limited to ethanol, butanol, isopropanol, propanol, to name only a few. The surfactant can be dissolved either in water or also in an alcohol.

In some embodiments the surfactant is used in a molar ratio to the organometallic precursor in a range between about 0.5 mol % to 10 mol % or 1 mol % to about 5 mol %, including the range from about 2 mol % to about 5 mol % or from about 1 mol % to about 8 mol %. In one embodiment the molar ratio between the surfactant and the organometallic precursor is about 1.2 mol %.

In case the sol is carried out by acidic catalysis the sol provided is acidified by adding an acid to the components. The acid can be either added already to the solution including the different components before mixing them together or the acid is added to the mixture of all components after they have been added together. The acidic solution has a pH between about 1 to 6, or between about 1 to 4, or between about 3 to 6. In one example, the pH is about 2 or 3 or 4 or 5 or 6.

For the above method any acid can be used. Examples of acids that can be used include, but are not limited to HCl, HNO₃, H₂SO₄, HClO₄, HBr, HCOOH or CH₃COOH.

The molar ratio of the organometallic precursor to the acid is between about 100/1 to about 5/1, or between about 50/1 to about 5/1, or between about 50/1 to about 10/1.

An organometallic precursor is generally formed from a metalloid or a metalloid compound that is dissolved in an acidic solution. A metalloid compound may for example be an organic metalloid compound (e.g. salt) such as silicon acetate or germanium acetylacetonate or titanium alkoxide or any other organic metalloid compound of any metal or metal compound mentioned above.

In some embodiments the metalloid precursor is an alkoxide such as a silicon alkoxide, a germanium alcoxide, a zirconium alcoxide, a titanium alkoxide or an aluminium alkoxide, to name only a few. Examples of silicon alkoxides include for instance methyl silicate (Si(OMe)₄), ethyl silicate (Si(OEt)₄) (TEOS), tetrabutoxysilane (TBOS), propyl silicate (Si(OPr)₄), isopropyl silicate (Si(Oi-Pr)₄), pentyl silicate (Si(OCH₅H₁₁)₄), octyl silicate (Si(OC₈H₁₇)₄), isobutyl silicate (Si(OCH₂₁Pr)₄), tetra(2-ethyl hexyl) orthosilicate (Si(OCH₂C(Et)ₙ-Bu)₄), tetra(2-ethylbutyl) silicate (Si(OCH₂CHEt₂)₄), ethylene silicate ((C₂H₄O₂)₂Si), tetrakis(2,2,2-trifluoroethoxy)silane (Si(OCH₂CF₃)₄), tetrakis(methoxy-ethoxy)silane (Si(OCH₂CH₂OMe)₄), benzyl silicate or cyclopentyl silicate.

Examples of germanium alkoxides include, but are not limited to, tetrapropyloxy-german, tetramethyloxygerman, o-phenylene germinate, ethylene germanate or 2,2′-spirobi[naphtho[1,8-de]-1,3,2-dioxagermin.

Examples of titanium alkoxides include, but are not limited to, triethoxy-ethyltitanium, triethoxymethoxytitanium, ethyl isopropyl titanate, tetrabutyl titanate, isopropyl propyl titanate, isopropyl methyl titanate, butoxytris(2-propanolato)titanium, monoisopropoxy-tributoxytitanium, butoxytris(1-octadecanolato) titanium or dibutoxybis(octyloxy)titanium. Three illustrative examples of a zirconium alcoxide are diethoxybis(2-propanolato)zirconium, octyl titanate and triethoxymethoxyzirconium. Further examples of organometallic precursor include aluminium chloride, indium chloride. It is also possible to use mixtures of different precursors in case mixed matrices, such as the silica-aluminate matrix or a zeolite matrix are to be manufactured. When selecting a metalloid alkoxide precursor it will be advantageous to keep in mind the relative reactivity of the metalloid compounds to hydrolysis and poly-condensation. As an illustrative example, titanium and zirconium compounds have a higher reactivity in this regard than e.g. silicon compounds. Accordingly, polycondensation of titanium n-propoxide is significantly easier to control than polycondensation of titanium i-propoxide.

In some embodiments a first solution of the at least one organometallic precursor and the heteropolyacid is prepared first and then added under stirring to the second solution comprising the surfactant. In another embodiment the sol is continuously stirred even after all components have been mixed together. The stirring time can be between about 30 minutes to about 5 h, including a period of time from about 30 minutes to about 4 h, a period of time from about 45 minutes to about 5 h, a period of time from about 45 minutes to about 4 h, a period of time from about 45 minutes to about 3 h or a period of time from about 45 minutes to about 2 h or a period of time from about 1 h to 2 h. The sol is usually formed at room temperature.

For stirring the stirring speed can be between about 50 to about 1000 rpm, or between about 200 to about 600 rpm, or about 200, or 300, or 400, or 500, or 600 rpm.

Depending on whether the sol-gel method is followed by a hydrothermal treatment, the aging step in the sol-gel method can comprise leaving the sol to evaporate (sol-gel method) or heating the sol at a temperature between about 80 to about 150° C. or between about 100 to about 120° C. at a pressure above atmospheric pressure (sol-gel-hydrothermal method). The latter one is generally carried out in an autoclave.

The hydrostatic pressure in the autoclave is determined by the degree of fill and temperature, and can be about atmospheric pressure or between about 100 kPa to 1,000 kPa. The upper operating pressure limit is determined by the autoclave capability while the lower pressure limit coincides approximately with the critical pressure of the gel forming within the autoclave which should be slightly exceeded.

After the hydrothermal treatment the gel can be left to dry. In case no hydrothermal treatment is used, the sol is left so that evaporation can take place and the gel forms. The temperature for this step is about ambient temperature or at a temperature in the range between about 30 to about 150° C., or from about 35° C. to about 100° C., from about room temperature to about 80° C., from about 35° C. to about 80° C., from about room temperature to about 65° C., from about 35° C. to about 65° C., from about room temperature to about 40° C., from about 35° C. to about 40° C. or it may also be selected to be about 35° C. or about 40° C.

In order to remove the surfactant, the dried gel may then be calcined. The heteropolyacid/mesoporous matrix electrolyte may for example be calcined in air, oxygen and/or in an air-ozone mixture at a temperature from about 200 to about 700° C., such as from about 200 to about 600° C. or about 300 to about 650° C. The calcination may be carried out for a period of time from about 1 to about 48 hours, such as for instance from about 2 to about 24 hours, or from about 2 to about 12 hours. The heating rate for calcination is between about 1° C./min to about 5° C./min, or about 1° C./min, or 2° C./min, or 3° C./min, or 4° C./min, or 5° C./min.

Calcination can be carried out under an atmosphere of nitrogen and/or oxygen. In one embodiment calcination is carried out in a first period under a stream of nitrogen and for a second period under an atmosphere of oxygen. The flow rate of the gas can be between about 20 mL/min to about 80 mL/min, or about 40 mL/min.

The methods described herein can further comprise the step of applying the sol onto a support material, such as a metal mesh or metal foam or porous metal substrate or porous metal support. Afterwards the sol applied onto the metal mesh or metal foam was aged as described above to obtain a gel incorporating a metal mesh or metal foam or porous metal substrate or porous metal support.

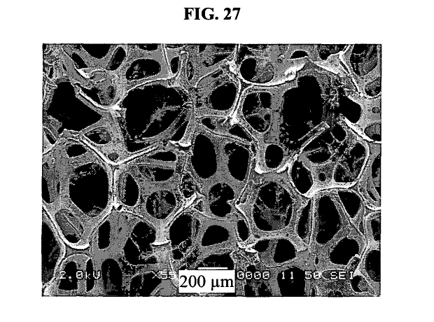

Metal foam is known to be a porous metallic body which can be solid or compressible (e.g. sponge-like structure). Such materials are known in the art. FIG. 27 shows for example a metal mesh, namely an SEM picture of a Ni-mesh.

Porous metal supports/substrates can be made from die-pressing or casting of metal oxide powders. Afterwards they are reduced in a reducing environment at high temperatures (the temperature lies in usually in the range of between about 600 to about 1200° C., depending on the reducing temperature of the metal oxide). Due to the volume change of metal oxide to metal, a porous metal support/substrate with any shape can be formed. The porosity of the metal support/substrate can also be controlled by adding pore-former such as carbon, graphite, PSS, etc. For example, porous Ni support/substrates can be made from NiO powders by the process described. NiO is reduced to Ni at temperatures of about 500 to about 600° C. or higher and volume reduction of NiO to Ni is about 21%.

The sol can be applied to the metal mesh or the metal foam or the porous metal substrate or the porous metal support by any method known in the art. In one embodiment, the sol is applied to the support material via spraying or co-pressing by uniaxil press and/or isostatic press.

The metal mesh or metal foam or porous metal substrate or porous metal support can be a made of a material that can include, but is not limited to titanium, antimony, cobalt, iron, manganese, silver, copper, lithium, rubidium, thallium, aluminium, barium, calcium, beryllium, magnesium, nickel, palladium, strontium, tin, vanadium, zinc, bismuth, boron, chromium, gallium, indium, tungsten, yttrium, cerium, germanium, ruthenium, selenium, tellurium, tantalum, niobium, molybdenum, alloys of the aforementioned metals and mixtures thereof.

The pores of the metal mesh or metal foam or porous metal substrate or porous metal support have a size<10 μm, or between about 1 μm to about 10 μm or between about 2 μm to about 5 or between about 1 μm to about 4 μm, or about 1, 2, 3, 4, 5, 6, 7, 8, 9, or μm. Such metal-supported electrolytes showed a high mechanical stability.

In one example, the sol applied on the metal mesh was left for evaporation at a temperature of about 40° C. for about 7 days before calcination.

In another aspect, the present invention is directed to a fuel cell comprising an inorganic mesoporous proton conducting electrolyte as described herein. This electrolyte is usable for fuel cell applications carried out at higher temperatures. A high temperature fuel cell operates at a temperature above 90° C. or 100° C. In one embodiment, the fuel cell operates at a temperature between above 100, or 200, or 300, or 400, or 500, or up to 600° C. In one embodiment, the fuel cell operates at temperatures about 100° C. to about 650° C., between about 500° C. to about 600° C., between about 100° C. to about 450° C., or between about 100° C. to about 300° C., or between about 200° C. to about 600° C., or between about 300° C. or 400 to about 600° C.

In one embodiment, the fuel cell is a direct alcohol fuel cell or direct hydrogen fuel cell. The catalyst used in these fuel cells can be a noble-metal catalyst or a non-precious metal catalysts, such as iron-chrome; pyrolized metal porphyrins, with cobalt and iron porphyrins; tungsten carbide; tungsten oxides; tin oxides; tungsten nitride; tungsten carbide supported on carbon; tungsten carbide/nitride supported on carbon nanotubes; Chevrel phase-type compounds (such as Mo₄Ru₂Se₈); transition metal macrocyclic complex and mixtures thereof.

In another aspect, the present invention is directed to a method of manufacturing an inorganic proton conducting electrolyte described herein, wherein the method comprises:
providing a mesoporous crystalline metal oxide matrix;
impregnating the mesoporous crystalline metal oxide matrix with a heteropolyacid.

With impregnating it is meant to saturate a mesoporous crystalline metal oxide matrix as described herein with a heteropolyacid as described herein. It has been demonstrated herein that such an electrolyte can also be used for fuel cell applications at high temperatures as indicated above.

For impregnation any conventional impregnation method known in the art may be used to prepare the electrolyte. Such methods include incipient wetness, adsorption, vacuum-assisted impregnation (VIM), deposition and grafting.

If the incipient wetness method is used, for example, a solution containing a heteropolyacid is first prepared. The matrix to be impregnated may be subjected to pre-drying at elevated temperatures overnight before impregnation. This drying step helps to remove any adsorbed moisture from the mesoporous matrix and to fully utilize the mesostructure for efficient and uniform impregnation with the heteropolyacid solution. The concentration of the heteropolyacid solution is prepared according to the desired heteropolyacid loading level. The wetted support is subsequently left to dry. The drying may be carried out by heating the wetted matrix.

In order to form an electrolyte comprising a homogeneous mixture of two or more heteropolyacids, it is possible to wet the mesoporous crystalline matrix in a mixture containing two or more of the desired heteropolyacids.

To obtain a higher content of heteropolyacids a vacuum-assisted impregnation (VIM) is carried out. Such an impregnation method comprises the steps of:
subjecting the mesoporous crystalline matrix to a vacuum; and
immersing the mesoporous crystalline matrix in a solution comprising the heteropolyacids or mixture of different heteropolyacids.

After immersing the matrix in a solution containing the heteropolyacid, the resulting electrolyte can be cleaned, washed, dried and stored. A schematic illustration of this procedure is illustrated in FIG. 24. In the example, illustrated in FIG. 24 the vacuum assisted impregnation method was carried out using a mesoporous crystalline SiO₂ matrix which was immersed in a solution comprising HPW.

In still another aspect, the present invention refers to an inorganic proton conducting electrolyte comprising a mesoporous crystalline metal oxide matrix and a heteropolyacid bound within the mesoporous matrix; wherein the inorganic proton conducting electrolyte is obtained or is obtainable by a method described herein.

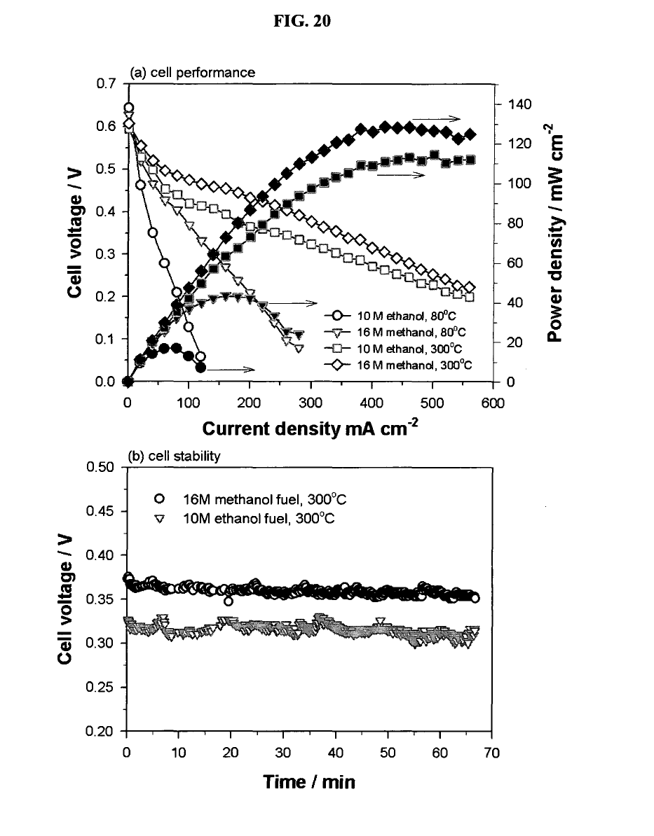

There are many possible applications for high temperature proton conducting materials. The most significant and commercially important application will be in the direct alcohol fuel cells. At a high temperature of between about 200 to 300° C., the electrooxidation reaction kinetics for methanol, ethanol and other liquid alcohol fuels will be significantly enhanced and this enhanced reaction kinetics would make the direct alcohol fuel cells practically possible. As demonstrated in the experimental section of this application, it is possible to develop a practical alcohol fuel cell based on liquid alcohol fuels such as ethanol and methanol with high performance and stability. The stability as shown in FIG. 20(B) indicates that the catalyst poisoning problems associated with low temperature direct alcohol fuel cells would be negligible or minimum. This substantially improves the durability of the direct alcohol fuel cells. The development of direct alcohol fuel cells such as direct ethanol fuel cells is seriously hindered by very low reaction kinetics and low electrocatalytic activity even with high loading of precious metal catalysts. The high operating temperature can enables the development of non-platinum catalysts for fuel cells. The use of non-platinum catalysts will substantially reduce the cost of fuel cells and make them commercially viable.

By “consisting of” is meant including, and limited to, whatever follows the phrase “consisting of”. Thus, the phrase “consisting of” indicates that the listed elements are required or mandatory, and that no other elements may be present.

By “comprising” it is meant including, but not limited to, whatever follows the word “comprising”. Thus, use of the term “comprising” indicates that the listed elements are required or mandatory, but that other elements are optional and may or may not be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXAMPLES

Manufacture of an Inorganic Proton Conducting Electrolyte Composite

A mesoporous HPW/silica electrolyte composite was prepared as follows. First, tetraethyl orthosilicate (TEOS, 99.9%, Sigma-Aldrich) was dissolved into an alcohol, such as ethanol. The dropwise addition of the 12-phosphotungstic acid (H₃PW₁₂O₄₀.nH₂O(HPW), analytically pure, Sigma-Aldrich) solution was carried out with vigorous stirring. P123 surfactant was prepared by dissolving P123 in ethanol. The mixed solution of TEOS/HPW was slowly added into P123 surfactant solution under vigorous stirring. The pH of the solution was then adjusted to 1 by adding HCl (2M) under stirring for 5 h. The molar ratio of the precursors and chemical used for synthesis of HPW/silica is x mole HPW: 0.1 mole TEOS: 0.0012 mole P123: 1 mole ethanol: 0.02 mole HCl: 2.5 mole H₂O. Uniform and transparent sol was obtained at room temperature. Table 1 indicates the molar ratio of HPW to TEOS for HPW/silica with different compositions. The sol was placed into Petri dishes or indium oxide (ITO) glass sheet or any container with flat bottom and let the sol to evaporate at 40° C. for ˜7 days. The mesoporous structure was formed by the evaporation-induced self-assembly (EISA) process. The powders were then collected and heated in a tube furnace with 40 mL/min N₂ flow at a heating rate of 1° C./min from room temperature to 350° C. for 5 h. Then the gas was changed to air with flow rate of 40 mL/min and the powder was calcined at 350° C. for another 5 h. The as-prepared HPW/silica powder was collected and stored.

TABLE 1
Molar ratios and weight percentage of HPW/silica
mesoporous composites.

| wt. % | HPW (mol) | TEOS (mol) |
|---|---|---|
| 5% | 0.00011 | 0.1 |
| 10% | 0.00023 | 0.1 |
| 15% | 0.00037 | 0.1 |
| 20% | 0.0005 | 0.1 |
| 25% | 0.0007 | 0.1 |
| 30% | 0.0009 | 0.1 |
| 35% | 0.00112 | 0.1 |

A mesoporous HPW/silica inorganic electrolyte proton exchange membrane (PEM) was prepared from the mesoporous HPW/silica composite powder using polyimide (PI) adhesive. Polyimide powder (16 wt %) mixed with n-methylpyrrolidone was mixed thoroughly with HPW/silica composite powder in an agate pestle mortar for 1 h. This mixture was dried at 180° C. for 2 h. The dried powder was then hot-pressed in a single-ended compaction stainless-steel die (5 cm diameter) under conditions of 380° C. and 30 MPa for 30 min. The obtained HPW/silica nanocomposite electrolyte membrane discs were translucent. FIG. 26a shows the optical micrograph of a finished HPW/silica electrolyte membrane disc for testing.

Manufacture of an Inorganic Proton Conducting Electrolyte Composite by Impregnation In this method, heteropolyacid (such as HPW) was impregnated into ordered mesoporous silica matrix by vacuum-assisted impregnated method (VIM). FIG. 24 shows schematically the procedure of the vacuum-assisted impregnation method. For the vacuum impregnation method, the porous matrix was placed under vacuum to remove trapped gas or impurities in the pores of mesoporous silica before the aqueous of HPW solution was added. Then the an aqueous HPW solution was introduced into the mesopores of the mesoporous silica matrix under vacuum. For these methods heteropolyacids can be dissolved in solvents also used for the sol-gel methods, i.e. alcohols and water. The vacuum assisted impregnation can be carried out for between about 5 h to about 48. In general, the method is carried out at room temperature. Compared with the conventional impregnation method (CIM) under ambient pressure, much more heteropolyacid molecules can be assembled into the nanochannels of mesoporous materials and form continuous proton channel by vacuum impregnated method. In one embodiment of HPW/silica with bicontinues 3D Ia3d mesoporous structure, the weight content of HPW in the nanocomposites was as high as 75 wt %. For example, the conductivity of HPW-MCM41 (one commercially available mesoporous silica) prepared by vacuum assisted impregnation method (VIM) with 25 wt. % HPW was in the range of 1.8×10⁻² to 4×10⁻²S/cm under 100% RH. The preliminary performance of PEMFC assembled with 25 wt % HPW/silica inorganic proton conducting membrane prepared by VIM as electrolyte shows a maximum power density 95 mW/cm² at 100° C. and 100% relative humidity.

Structure Characterization, Surface and Stability of Mesoporous HPW/Silica Inorganic Electrolyte Proton Exchange Membrane

Transmission electron microscopy (TEM)—TEM images were taken with a high resolution TEM (JEM-2010FEF) at 200 kV. FIG. 1 displays the high resolution TEM images of the mesoporous HPW/silica inorganic electrolyte proton exchange membrane with various HPW contents from 10 wt % to 35 wt %. The results exhibit uniform mesoporous arrays with long-range order when HPW content in the complex is lower than 25 wt %. The distance between silica arrays (pore diameter) of these samples is about 3˜4 nm. However, further increase of HPW content could affect the ordered silica mesoporous structure. When the HPW content in the composite increased to 35%, the structure becomes disordered and well-ordered mesoporous structure starts to collapse (FIG. 1d). The maximum content of heteropolyacid at which the mesoporous matrix structure collaps can differ depending on the material used for the manufacture of the mesoporous matrix.

XRD & surface area—Small-angle X-ray diffraction (SAXRD) patterns of HPW/silica composite were recorded on a Rigaku D/MAX-RB diffractometer with a CuKa radiation operating at 40 kV, 50 mA. Nitrogen adsorption-desorption data were measured with a Quantachrome Autosorb-1 analyzer at 77K. Prior to the surface area measurement, the samples were degassed at 200° C. for at least 3 h. The surface area was calculated by the Brunauer-Emmett-Teller (BET) method. The pore-size distribution was derived from the adsorption curve of the isotherms using the Barrett-Joyner-Halenda (BJH) method.

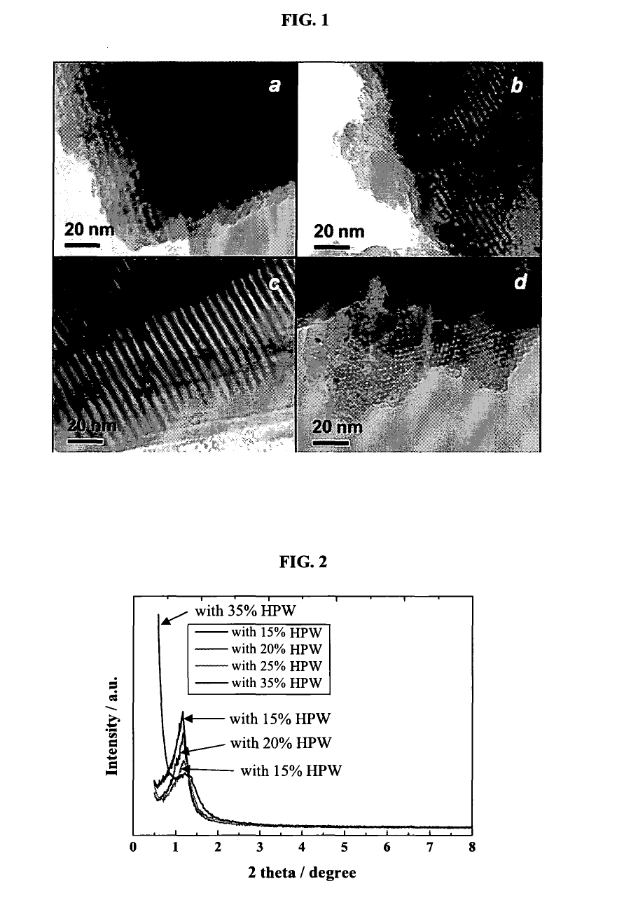

FIG. 2 shows small-angle XRD (SAXRD) patterns of the mesoporous HPW/silica composite. The results of samples with HPW content of 10-25 wt % presents well-resolved diffraction peaks with d-spacing ratios of 1:\sqrt{3}:2 at 2θ angle of 1.3˜1.5°, which can be indexed as the (100) reflections of typical 2-D hexagonal mesostructure and demonstrates the long-range arrangement of TEM results. Further calculation of the arrangement cell parameters, a, was based on the equation that a=2d(100)/3^{1/2} and the results for 10%, 15% and 25% are 9.6, 9.8 and 9.9 nm. The consistence of the cell parameters (α) in spite of the HPW content increase suggests that the mesoporous structure formation is mostly controlled by the reaction of silica during the hydrolysis reaction, and aggregation of HPW molecules in the HPW/SiO₂ composite does not occur during the synthesis process. When HPW content in the HPW/SiO₂ composite increased to 35 wt %, shrinkage of the diffraction peak (100) of about 50% is observed. At the same time, the diffractions slightly shift to the high angles, suggesting the degradation of the ordered mesostructure, consistent with the TEM investigations.

N₂ adsorption-desorption isotherms of mesoporous HPW/SiO₂ composites show typical type IV curves with a sharp capillary condensation step at relative pressure (P/P₀) of about 0.6, as shown in FIG. 3, suggesting a very narrow pore size distribution. The hysteresis loop is very close to H1 type, implying uniform cylindrical pore geometry. The pore size (main graph of FIG. 3) calculated from the adsorption data using the BJH model is in the range of 3.2˜3.5 nm. Table 2 presents the parameters of the mesoporous HPW/silica nanocomposite calculated from the SAXRD and N₂ adsorption-desorption isotherms. The d(100) spacing measured by SAXRD is also given in the Table. The wall thickness of the mesopores calculated from the pore size and unit cell (thickness=α−pore size, where α is obtained from the XRD analysis) is about 6.4˜6.7 nm, which is essentially the same as that measured from the TEM images. The slightly increase in the wall thickness and pore size of the mesoporous composite also demonstrated the anchor of HPW molecules with contents of ≦25 wt % in the silica structure are well-dispersed without agglomeration.

TABLE 2
Structural parameters of the mesoporous HPW/SiO₂ nanocomposites
comprising various HPW contents.

| | | | | Wall |
|---|---|---|---|---|
| | d(100) | a/ | Pore size/ | thickness/ |
| Samples | spacing/nm | nm | nm | nm |
| HPW/SiO₂-10 wt % HPW | 8.26 | 9.6 | 3.2 | 6.4 |
| HPW/SiO₂-15 wt % HPW | 8.43 | 9.8 | 3.3 | 6.5 |
| HPW/SiO₂-25 wt % HPW | 8.61 | 10.2 | 3.5 | 6.7 |

Stability—Application of heteropolyacid as electrolyte material is considered to be limited due to the inherent solubility of HPA in water. The stability or bleeding of HPW in the mesoporous HPW/silica electrolyte membrane was investigated by immersing the sample in 500 mL DI water. The water was refreshed every 24 hrs. Ion exchange capacity (IEC) of the mesoporous HPW/silica electrolyte membrane was determined by titration. Membrane samples were soaked in 50 mL of 1M NaCl aqueous solution for 24 h, and then titrated with 0.01 M NaOH solution.

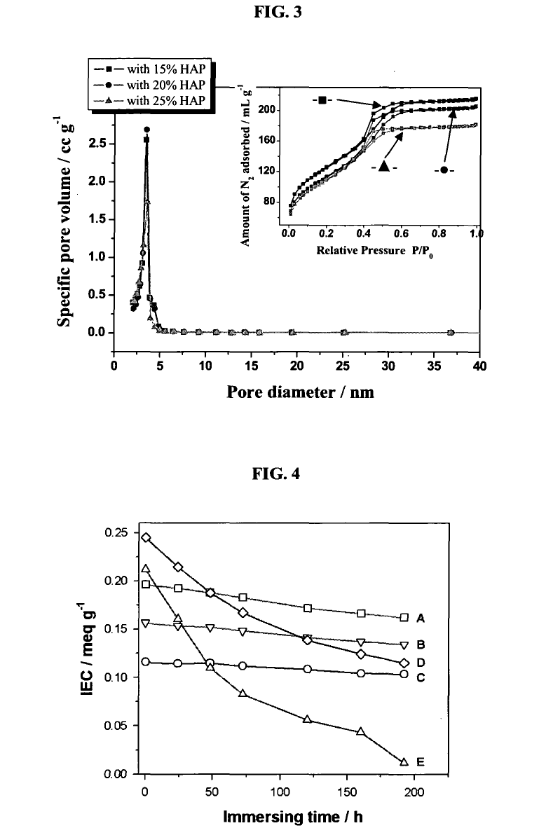

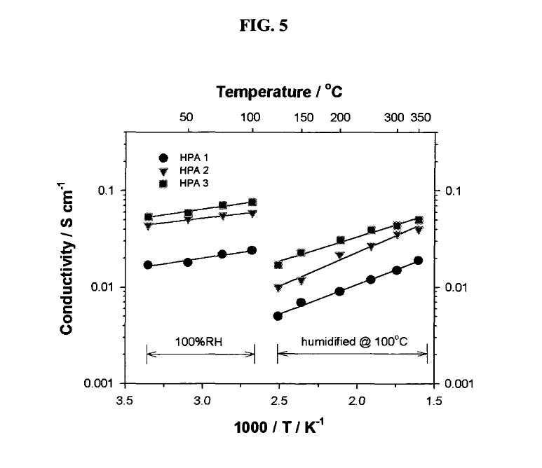

FIG. 4 reveals the ionic exchange capacity (IEC in meq/g) loss of mesoporous HPW/SiO₂ inorganic membranes with various HPW content ((A) 15 wt % HPW; (B) 20 wt % HPW; (C) 25 wt % HPW; (D) 35 wt % HPW). As a comparison, HPW-SiO₂ complex prepared by direct mixing and sintering of 25 wt % HPW and 75 wt % Silica (E) was also tested in the investigation. The result displayed a rapid HPW loss of the direct mixed HPW/silica composites. However, the mesoporous HPW-SiO₂ inorganic electrolyte membranes is rather stable in the solution. For the samples of HPW content lower than 25 wt %, the HPW molecule is very stable and the IEC value can maintain higher than 0.1 meq/g. The results also demonstrated the stability of HPW molecules is very much related to the degree of the order of the mesoporous structure. For the mesoporous HPW-SiO₂ with HPW content of 35 wt %, the IEC loss rate is much higher than the other three samples because the destruction of the ordered mesoporous structure.

Thermal stability of mesoporous metal matrix—In a further experiment the thermal stability of a HPA/silica inorganic electrolyte has been investigated. 2-D continues HPA/silica mesoporous materials were used as the electrolytes for the testing of the chemical stability of the structure. The stability of the HPA Keggin ions can be demonstrate by FTIR in terms of W—O—W vibrations of edge and corner sharing W—O₆ octahedra linked to the central P—O₄ tetrahedra, as shown in FIG. 9. The stretching modes of edge-sharing W—O_{b}—W and corner sharing W—O_{c}—W units appear at 890-900 and 805-810 cm⁻¹, respectively, whereas the stretching modes of the terminal W—O_{d} units are at 976-995 cm⁻¹. As displayed in FIG. 9, the FTIR bands at ca. 1079 cm⁻¹, respect the stretching frequency of P—O in the central PO₄ tetrahedron. The reflection mode of the W—O_{c}—W bands in the as-prepared gel electrolyte (samples before sinter) shift from 805 (HPW) to 810 cm⁻¹ (HPW/SiO₂), suggesting the chemical interactions between the HPW anion and the SiO₂ framework. The presence of the stretching bands of W—O_{d}, W—O_{b}—W and W—O_{c}—W units in the HPW/silica electrolyte samples heat-treated at 450° C., 550° C. and 650° C. demonstrated the thermal stability of the HPW Keggin units in the highly ordered silica because of the capillaries structure of the silica framework. After heat-treated at 750° C., the reflection of the P—O bands at 1079 cm⁻¹ and the W—O_{d} bands at 983 cm⁻¹ strengthened, suggesting the transformation of the HPA keggin structure.

FIG. 10 presents the SAXS and TEM micrographs of an HPA/silica electrolyte after heat-treatment at various temperatures for 2 h. As displayed in the SAXS patterns, the electrolyte typically have 2D continues proton transportation pathway and the highly ordered microstructure is stable or even strengthened after heat-treated at 450˜650° C. TEM micrograph (pictures on the right side of the graph in FIG. 10) also demonstrated the structure stability of the HPA/silica structures. The nanochannels of the silica framework became even more regular after heat-treating at high temperature. This structure evolution can be clearly observed in the diffraction pattern of the electrolyte samples. The nanochannel diameter became more uniform after the heat treatment. The results indicate that the ordered mesoporous structure of HPW/silica is stable at temperatures as high as 650° C.

Proton Conductivity of a Heteropolyacid/Metal Matrix Nanocomposite Membrane

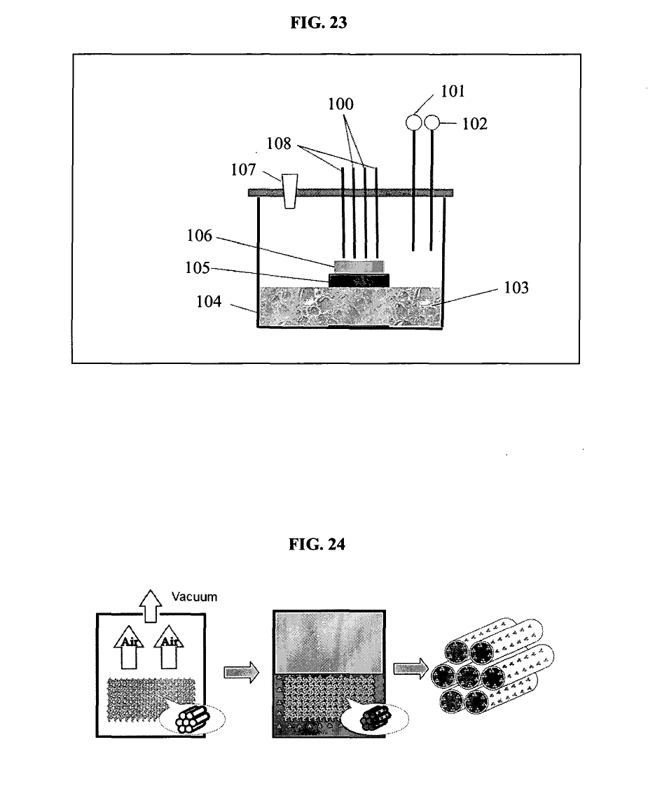

Proton conductivities of a HPW/silica nanocomposite electrolyte membrane were measured by using an impedance analyzer (Autolab PG30/FRA, Eco Chemie, The Netherlands). Samples were sandwiched between two Pt sheets (2 cm×2 cm) in contact with graphite plate under pressure. The temperature was controlled by an Elstein ceramic infrared radiator. One Pt sheet was used as the working electrode and the other as the reference and counter electrodes. EIS was measured in the frequency range of 10 Hz to 100 kHz under the signal amplitude of 10 mV. For the conductivity measurements at temperature range of 25˜100° C., the membrane samples were placed in a temperature-controlled water bath with 100% relative humidity. FIG. 23 shows the schematic diagram of the membrane conductivity measurements with 100% RH. The membrane (106) sample with two voltage probes (100) and two current probes (108) was placed on the surface of a support (105), which was placed inside a temperature-controlled water bath (104). Pt or Ag wires were used as the voltage (100) and current probes (108). The temperature and humidity (i.e., the vapour pressure of water (103)) were controlled by the water bath temperature controller and measured by thermometer (101) and hygrometer (102), respectively. The pressure release valve (107) ensures that the pressure inside the water bath (104) was constant during the measurement. Equilibrium was achieved before the test. Current was passed through the current probes (108) and voltage was measured between the voltage probes (100). The conductivity was measured by Electrochemical Impedance Spectroscopy (EIS). In the case of measurements at temperatures higher than 100° C., the relative humidity was controlled by Greenlight G50 test station (Greenlight Innovation Corp, Canada).

FIG. 5 shows the proton conductivity curves of a mesoporous HPW-SiO₂ nanocomposite membrane measured at temperatures up to 35° C. Under conditions specified in FIG. 5, the conductivity increases with the increase of HPW content in the mesoporous membrane. For the 25 wt % HPW membrane at condition of 100° C. and 100 RH % gas humidifying, the proton conductivity achieves 0.076 S/cm, significantly higher than the value of HPW contained inorganic composite prepared by the traditional sol-gel derived HPW/silica composite not using a template. The excellent conductivity should be contributed to the continued proton conducting channel structured by the anchored HPW molecules in the well-ordered mesoporous SiO₂ structure. The highly-ordered proton conducting channels indicate that the proton can easily move through the membrane. Another distinct advantage of the HPW/silica nanocomposite is that the size of proton conducting channels is about 3.2˜3.5 nm, as shown by the SAXRD and the N₂ adsorption-desorption isotherms results (supra). The ordered porous channels of the mesoporous SiO₂ is similar to the proton conducting channels of the well-known Nafion® polymer electrolyte, promoting the proton conductivity. Compared to condensed materials, the nanostructured conducting channel permit the impregnation and exchange of hydrated H⁺ ions, enhancing the proton transfer.

Most important, FIG. 5 also reveals excellent proton conductivities of the mesoporous inorganic electrolyte membrane under the temperature of 125˜300° C. and the gas was humidified at 100° C. (it should be noted that the RH will change with the testing temperature). At high temperatures, the proton conductivity is attributed to the condensed water molecules in the HPW molecules trapped inside the mesoporous silica. Water could be maintained in the Keggin-type HPW at temperatures of 300° C. (573 K) due to the strong capillary force. Even under an elevated temperature higher than 300° C., the HPW molecules are proton conductive because of the high acidity. Adsorbed water molecules would desorb from the Keggin unit at temperatures higher than 300° C., facilitating the proton transfer inside the mesopores. The proton conductivity of the 25 wt % HPW mesoporous membrane is ˜0.05 S/cm. This is probably the highest conductivity value ever reported for the heteropolyacid-based electrolyte materials.

The activation energy for the proton conductivity of a HPW/silica nanocomposite membrane is 3.6-4.5 kJ/mol under 100% RH humidified conditions and 9.5-13.2 under humidification at 100° C.

Conductivity Stability of Heteropolyacid/Metal Matrix Electrolyte

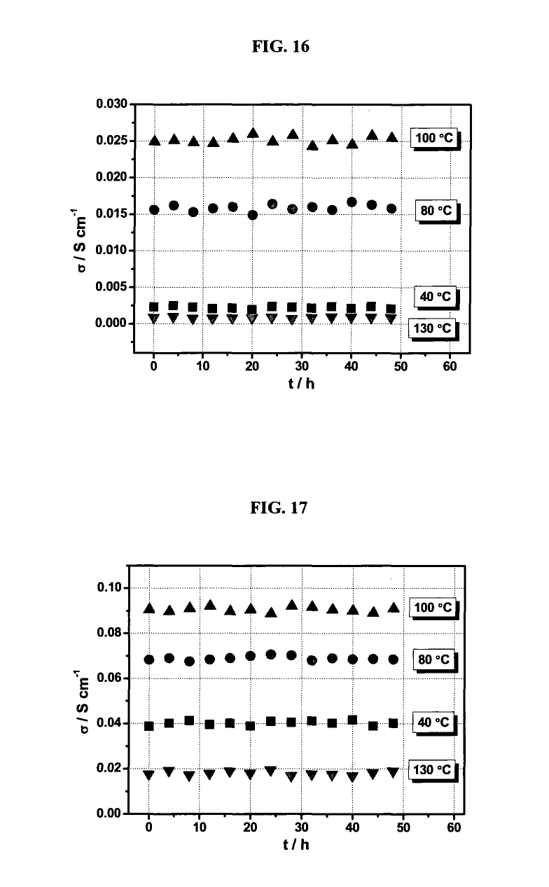

The stability of proton conductivity of HPW/silica mesoporous composite was studied under various temperatures and humidity conditions by four-probe electrochemical impedance measurements. The duration of the test was ˜50 hrs and the results are shown in FIGS. 16 and 17.

The stability of the electrolyte proton conductivity is an important parameter for fuel cells. At this stage it is not practical to test the fuel cell stability at high temperatures as the fuel cell stability depends not only on the stability of the electrolyte conductivity but also on the stability of the electrocatalysts for the fuel cell reactions at high temperatures. The stability test results on the HPW/silica mesoporous electrolyte in the temperature range of 40-130° C. indicate that the mesoporous HPW/silica electrolyte is structurally stable and HPW molecules trapped inside the mesoporous structure are stable under fuel cell operation temperatures. The reduced conductivity at 130° C. is simply due to the significant reduction in relative humidity (RH=18% in this case). To maintain high RH at temperatures above 100° C., pressurized test station can be used. The test station used herein is for normal atmosphere use.

The conductivity of about 0.02 S/cm at 130° C. (FIG. 17) is a good value for fuel cell applications.

A Heteropolyacid/Metal Matrix Electrolyte with Different Mesostructures

A HPW/silica mesoporous electrolyte is based on SBA-15 structure and has a 2-D continuous channel. However, the mesoporous silica can be formatted to various ordered structure such as two-dimensional 2D hexagonal structure (SBA-15, SBA-8, MCM-41 and KSW-2, etc.), three-dimensional (3D) hexagonal structure (SBA-16, FDU-1, FDU-2 and SBA-2, etc.), and bicontinuous cubic 3D structure (KIT-6, FDU-5, AMS-10 AND MCM-48, etc.). The increase of topological curvatures of the mesoporous structure may improve and enhance the nanochannel connection and transportation of protons between the close-packing particles of HPW/silica nanocomposites when used as PEM for fuel cells.

HPW/mesoporous silica electrolyte with structures of p6 mm, im3m, fm3m, ia3d (FIG. 11) and lamellar have been manufactured through the self-assembly processes. In one embodiment, the 3D mesoporous structures were synthesized via a hydrothermal method. In this method, pluronic surfactant P123 or F127 or F108 was dissolved in distilled water and hydrochloric acid (37 wt %). After complete dissolution, butanol is added to the solution and the temperature was maintained at 45° C. TEOS or HPW/TEOS was added after 1 h of stirring, then the solution mixture was put into a polypropylene bottle and closed (which will produced a positive pressure due to the evaporation of the solvent inside the bottle). The mixture was further stirred vigorously at 45° C. for 24 h. The stirring speed was 400 rpm. Subsequently, the solution mixture was aged at 100° C. for 24 h under static conditions. Table 3 defines the compositions of surfactant, TEOS and other precursors for the preparation of HPW/silica with selected structures. The molar ratio and weight percentage of HPW/silica mesoporous membranes follow the same calculation as shown in Table 1.

TABLE 3
Compositions of surfactant, TEOS and other precursors for the
preparation of HPW/silica with selected 3D mesoporous matrix.

| | HPW(g) | Butanol(g) | | TEOS(g) | HCl(g) | H₂O(g) |
|---|---|---|---|---|---|---|
| Reagents | | | P123(g) | | | |
| Bi- | x | 4 | 4 | 8.6 | 7.9 | 144 |
| continuous | | | | | | |
| 3D | | | | | | |
| structure | | | | | | |
| (Im3d) | | | | | | |
| Samples | | | F127(g) | | | |
| Cubic- | x | 9 | 3 | 14.2 | 5.94 | 144 |
| center | | | | | | |
| 3D | | | | | | |
| structure | | | | | | |
| (Im3m) | | | | | | |
| Face- | x | 0 | 3 | 14.4 | 6.3 | 144 |
| center | | | | | | |
| 3D | | | | | | |
| structure | | | | | | |
| (Fm3m) | | | | | | |

As the SAXS and N₂ adsorption/desorption isotherms shown in FIG. 12, The p6 mm electrolyte have a typical 2D continues channels which facilitate proton transportation through the nanochannel pathway. The structure im3m has a body-centered three-dimensional (3D) hexagonal structure with symmetrical packing spherical cages and the Fm3m structure has a face-centered 3D hexagonal structure that might preserve the inherent HPW more strongly and improve the durability of the electrolyte conductivity. From the N₂ adsorption/desorption isotherms, constricted cylindrical pore can be clearly observed. Desorption from the cavity is delayed until the vapor pressure is reduced below the equilibrium desorption pressure from the pore windows. A HPW/silica electrolyte with bicontinuous cubic Ia3d structure has also been synthesized. By adjusting the phase separation and surface tension of the colloidal solutions as described above (different surfactant or different concentration ratio), the minimal surface of the silica divides the space into two enantiomeric separated 3D helical pore systems, forming a cubic bicontinuous structure. The resultant electrolyte with the 3D bicontinuous mesochannels shows type-IV sorption isotherms and a narrow pore size distribution. Disordered micropores with diameters of 1˜2 nm are found to form interconnections between two main channels. In this case, the ordered proton transportation channels are connected so that the proton can be transferred in the electrolyte more freely.

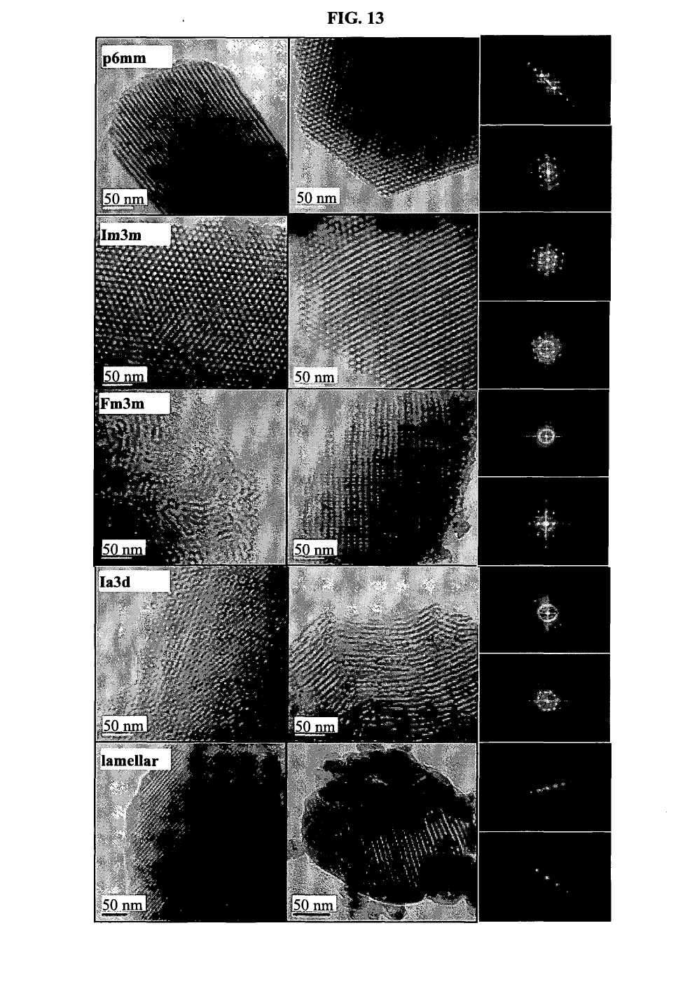

Typical morphologies of the HPW/silica electrolyte with different mesostructures are displayed in FIG. 13. The results are very consistent with that of the SAXS and the N₂ adsorption/desorption isotherms. For the p6 mm mesoporous electrolyte, the microstructures are hexagonally close packed with cylindrical pore channels consistent with the p6 mm space group. The diffraction spots of the sample also demonstrated the 2D hexagonal mesostructure with standard patterns. The particle size of the p6 mm HPW/silica mesoporous composite can also be controlled to construct close-packed electrolyte membrane for fuel cells. During the structure evolution, the polymerization of the silica molecules is prevented and this is indicated by the hexagonal profiles of the mesoporous particles observed from the TEM. Characteristic morphologies of the 3D electrolyte are also demonstrated by the TEM results. For the lamellar electrolyte, only layer to layer structure is found in the TEM profiles.

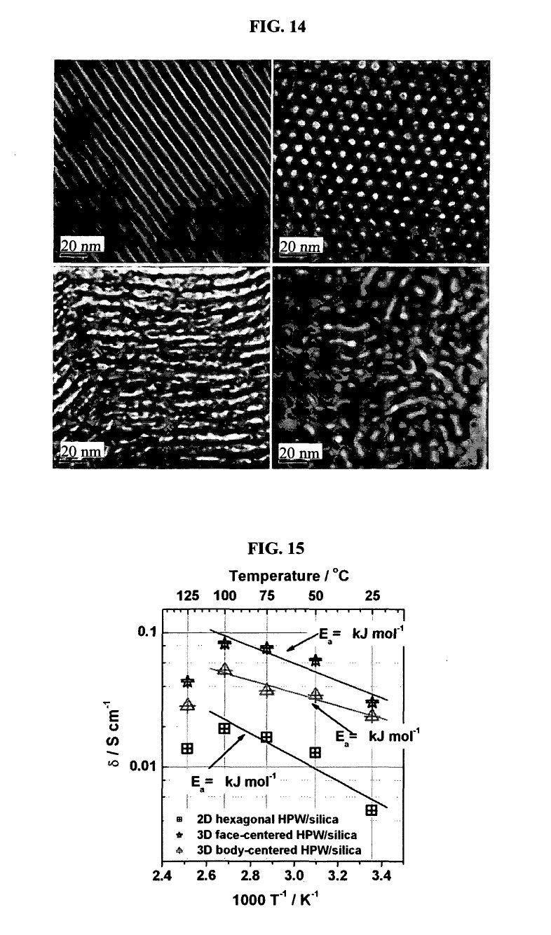

Nanochannels in the HPW/silica mesoporous electrolyte are displayed in FIG. 14. With the change of electrolyte microstructures, the nanochannels of the electrolyte, namely the proton transportation pathways, are changed from a 2D hexagonal mesostructure to three-dimensional hexagonal structure and bicontinuous cubic Ia3d structure. The 2D hexagonal channels have pathway diameter of about 8˜10 nm with the silica framework thickness of about 3˜5 nm. The channels diameter of the three-dimensional hexagonal structure is also about 8˜10 nm, whereas the framework thickness seems larger. Sinuousness nanochannels also frequently found in the three-dimensional hexagonal electrolyte at the fm3m framework, implying the concentration of three-dimensional structure. For the bicontinuous cubic Ia3d structure, the cross-linked nanochannel can be clearly observed by the TEM profiles.

Micropores with different diameters also clearly seen in the micrograph, which is consistent with the N₂ adsorption/desorption results. The interconnections of main channels with the micropores construct a cross-linked network, which is favourable to the proton transportation.

The conductivity of HPW/silica inorganic electrolytes with different mesoporous structures is shows in FIG. 15. The conductivity measurement indicates that mesoporous HPW/silica with 3D structure shows high proton conductivity as compared to that of the 2D structure.

Development of Metal-Supported HPW/Silica Mesoporous PEM Fuel Cells

A membrane-electrode-assembly (MEA) was prepared through in-situ route. In this method, uniform and transparent sol obtained at room temperature was prepared according to synthesis process described above. The sol was then carefully sprayed into a fine nickel mesh (pore size: <˜5 micrometer), and slowly evaporate at 40° C. for ˜7 days. The mesoporous SiO₂/HPW film on Ni mesh was formed by calcinations at 350-450° C. with a heating rate of 2° C./min.

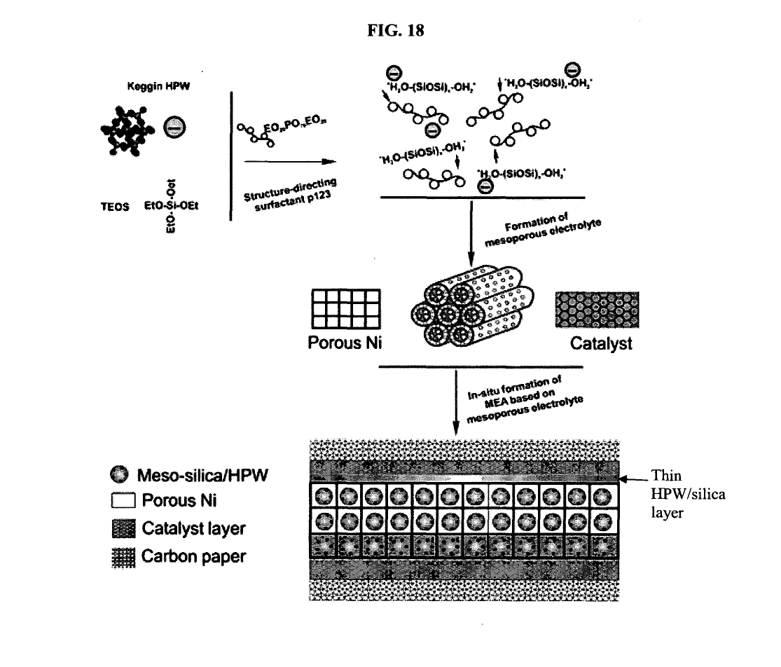

MEA was prepared by directly growth and formation of the inorganic electrolyte nanostructure on a porous metal support. This structure has high mechanical stability at elevated temperatures. FIG. 18 shows a schematic diagram of the fabrication process of the metal-supported HPW/silica mesoporous electrolyte-based MEA. In the MEA illustrated in FIG. 18, a layer of catalyst, such as Pt black, is arranged on a backing structure, in this case carbon paper. A mesoprous heteropolyacid/metal matrix electrolyte is formed directly on the catalyst layer and a porous metal layer, such as a porous Ni-layer is further incorporated into the arrangement so that the heteropolyacid/metal matrix electrolyte penetrates the upper surface of the catalyst layer and entirely penetrates the porous Ni-layer. On top of the Ni-supported electrolyte layer a thin layer made of a pure HPW/metal matrix can be applied to prevent the short-circuit of the Ni-supported electrolyte. This thin layer is then followed by another catalyst forming the opposite electrode which is also attached to a backing structure, in this case also carbon paper.

Performance of Cells Based on a Mesoporous Heteropolyacid-Silica Mesoporous Composite Membrane

For direct alcohol fuel cells—A high temperature PEM fuel cell was fabricated by mounting a mesoporous HPW/silica nanocomposite membrane coated with a catalyst in a fuel cell clamp (with an active area of 4 cm²) with Ni mesh (pore size of 0.5˜1 μm) as gas diffusion layer and polyimide as seal materials. The thickness of the mesoporous HPW/silica nanocomposite membrane was 160±5 μm. Pt black was used as electrocatalyst for both anode and cathode. The MEA was prepared by coating 1 mg cm⁻² Pt black on two sides of the inorganic electrolyte membranes as anode and cathode. The performance was measured at fuel cell test station (ElectroChem., USA) using 16 M methanol or 10 M ethanol (alcohol/DI water volume ratio of about 3/7) as fuel and oxygen as oxidant without back pressure. Oxygen flow rates were both 600 cm³/min, methanol/ethanol flow rates were 20 ml/min. The methanol/ethanol solution was pre-heated to gas state by using an oil bath (ethylene glycol, 160° C.) between cell inlet and the peristaltic pump.

FIG. 20 shows the performance of single cells assembled by 25 wt % HPW-SiO₂ inorganic membranes as the electrolyte, 1.0 mg/cm² Pt black as the anode and 1.0 mg/cm² Pt black as the cathode. At 80° C., the cell performance for direct alcohols is very low, particularly for direct ethanol. The maximum power density is 16.8 and 43.4 mW/cm² for direct ethanol and methanol, respectively, indicating very low electrocatalytic activity of Pt black and low reaction kinetics of ethanol and methanol electrooxidation at 80° C. However, the cell performance increases significantly with the increase in the operating temperature. As the temperature is raised to 300° C., the maximum power density is 112 mW/cm² for direct ethanol and 128.5 mW/cm² for direct methanol that is 6.6 and 3 times higher than that at 80° C. Most important, the cell performance is stable for direct alcohol fuels (FIG. 20b) and no sharp drop in the cell voltage as commonly observed for the direct alcohol fuel cells at low temperatures. This indicates the elimination or negligible poisoning effect of the alcohol reaction on the Pt black catalysts. The results demonstrated feasibility of direct alcohol fuel cells based on a high temperature HPW/silica proton conducting nanocomposite membrane.

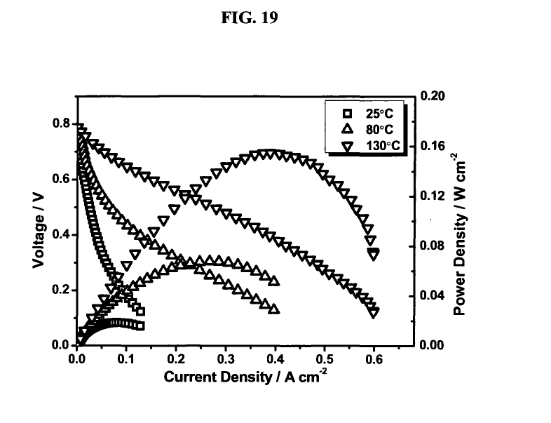

In a further experiment, a membrane-electrode-assembly (MEA) was sandwiched and sealed in a stainless steel cell test fixture. A 1.0 M methanol solution was used as fuel and the flow rate was 10 ml/min. The fuel was preheated before flowing to the cell at 25° C., 80° C. and 100° C., which are corresponding to the cell operating temperature, 25° C., 80° C. and 130° C., respectively. The O₂ without pre-heating was supplied to cathode with a flow rate 100 SCCM (166*10⁻³ Pa*m³/s). The RH for the performance measurements at 25° C. and 80° C. was 100% and for the performance measurement at 130° C., the humidity was controlled at 100% at 80° C.; this corresponds to a RH of 18% at 130° C. The test results are displayed in FIG. 19. As the result, the current density and power density increased with the heating of the cell chamber. The open circuit voltage (OCV) of the cell with inorganic membrane is about 0.8 V, significantly higher than 0.6 V for the Nafion®-based cells at room temperatures. This indicates the reduced methanol crossover at high temperatures. The maximum power density of about 20 mW cm⁻² at room temperature, which is in the similar range of the direct methanol fuel cells based on Nafion® membranes. The power density increased to about 160 mW/cm² when cell temperature increased to 130° C. The significantly improved performance at high temperature is a clear indication of the significantly enhanced electrochemical reaction kinetics and high proton conductivity of the HPW/meso-silica membrane. FIG. 26b shows the optical micrograph of the cell tested.

For direct hydrogen fuel cells—A PEM fuel cell was fabricated by mounting a HPW/silica (25 wt % HPW) nanocomposite membrane coated with a catalyst in a fuel cell clamp (with an active area of 4 cm²) with Ni mesh (pore size of 0.5˜1 μm) as gas diffusion layer and polyimide as seal materials. The anode and cathode catalysts were kept as 0.4 mg/cm² Pt black. The performance was measured with a fuel cell test station (ElectroChem., USA) using H₂ as fuel gas and oxygen as oxidant without back pressure. H₂ and oxygen flow rates were both 600 cm³/min.

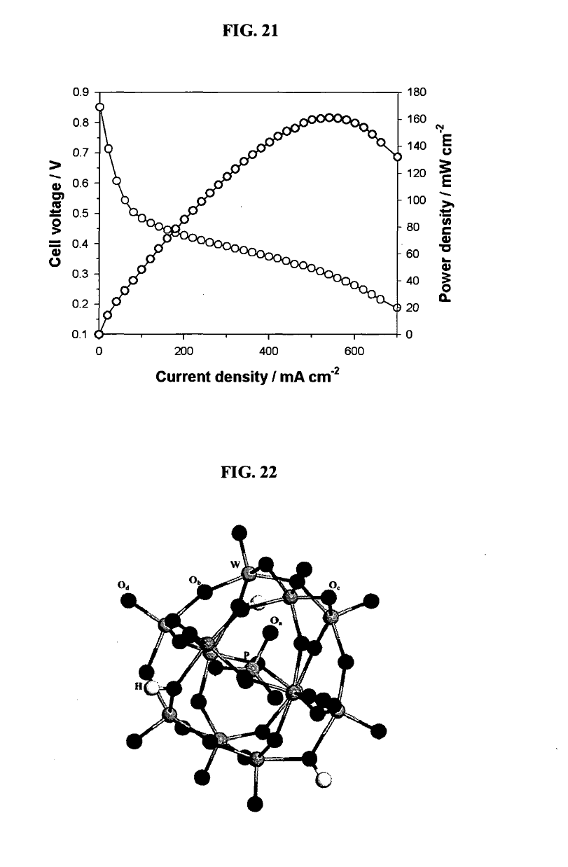

FIG. 21 shows the performance of single cells assembled by 25 wt % HPW-SiO₂ inorganic membranes as the electrolyte, 0.4 mg/cm² Pt black as the anode and cathode. The cell performance with Pt black anode and cathode achieved a maximum power density of about 162 mW/cm² at 80° C. This demonstrates that ordered mesoporous HPW/silica nanocomposite can also be used for direct hydrogen fuel cells.

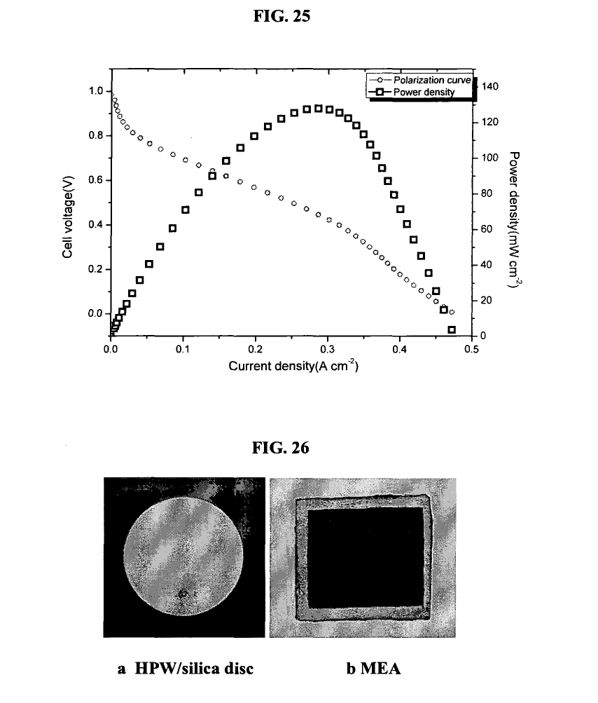

FIG. 25 shows the performance of a single cell assembled by 75 wt % HPW-silica inorganic membrane as the electrolyte, 0.5 mg/cm² Pt black as the anode and cathode. The cell performance with Pt black anode and cathode achieved a maximum power density of about 130 mW/cm² at 50° C. The mesoporous silica has a bicontinues 3D Ia3d structure with the average mesopore diameter of ˜8.3 nm and prepared by hydrothermal induced self-assembly method. 75 wt % HPW was impregnated into mesoporous silica matrix by vacuum-assisted impregnation method.

1. An inorganic proton conducting electrolyte consisting of a mesoporous crystalline metal oxide matrix and a heteropolyacid bound within the mesoporous matrix.

2. The inorganic proton conducting electrolyte according to claim 1, wherein the mesoporous metal oxide matrix is selected from the group consisting of a mesoporous crystalline silica matrix, a mesoporous crystalline silica-aluminate matrix and a mesoporous crystalline zeolite matrix.

3. The inorganic proton conducting electrolyte according to claim 1 or 2, wherein the structure of the inorganic electrolyte is stable at temperatures up to 650° C.

4. The inorganic proton conduction electrolyte according to claim 1 or 2 or 3, wherein the inorganic proton conduction electrolyte is functional up to a temperature of about 600° C.

5. The inorganic proton conducting electrolyte according to any one of the preceding claims, wherein the mesoporous crystalline metal oxide matrix comprises a mesostructure with at least one dimension in the range of between about 2 to 50 nm.

6. The inorganic proton conducting electrolyte according to claim 5, wherein the mesoporous crystalline metal oxide matrix comprises a mesostructure with at least one dimension in the range of between about 3 to 10 nm.

7. The inorganic proton conducting electrolyte according to any one of the preceding claims, wherein the heteropolyacid bound in the crystalline metal oxide matrix adopts at least one structure which is selected from the group consisting of the Keggin structure, the Silverton structure, the Dawson structure, the Waugh structure, and the Anderson structure.

8. The inorganic proton conducting electrolyte according to claim 7, wherein the heteropolyacid has the general formula (I):
H₃MX₁₂O₄₀ (I);
wherein
M is the central atom which is either P or Si or Ge or As;
X is the heteroatom which is either V or W or Mo.

9. The inorganic proton conducting electrolyte according to claim 7, wherein the heteropolyacid has the general formula (II):
Cs_{z}H_{3-z}MX₁₂O₄₀ (II);
wherein
M is the central atom which is either P or Si or Ge or As;
X is the heteroatom which is either V or W or Mo; and
z is 0≦z≦3.

10. The inorganic proton conducting electrolyte according to any one of claims 1 and 3 to 9, wherein the metal of the mesoporous metal oxide matrix is selected from the group of metals consisting of silicon, titanium, phosphor, antimony, cobalt, iron, manganese, silver, copper, potassium, rubidium, thallium, sodium, aluminium, barium, calcium, beryllium, magnesium, nickel, palladium, strontium, tin, vanadium, zinc, boron, chromium, gallium, indium, tungsten, yttrium, cerium, germanium, ruthenium, selenium, tellurium, tantalum, niobium, and molybdenum, rhenium, praseodymium, neodymium, samarium, europieum, holmium, thorium, uranium, barium, plutonium, neptunium, lanthanum, and strontium.

11. The inorganic proton conducting electrolyte according to any one of claims 1 and 3 to 10, wherein the metal oxide is selected from the group consisting of silicon dioxide (SiO₂), titanium dioxide (TiO₂), antimony tetroxide (Sb₂O₄), cobalt(II,III) oxide (CO₃O₄), iron(II,III) oxide (Fe₃O₄), manganese(II,III) oxide (Mn₃O₄), silver(I,III) oxide (AgO), copper(I) oxide (Cu₂O), potassium oxide (K₂O), rubidium oxide (Rb₂O), silver(I) oxide (Ag₂O), thallium oxide (Tl₂O), aluminium monoxide (A10), barium oxide (BaO), beryllium oxide (BeO), cadmium oxide (CdO), calcium oxide (CaO), cobalt(II) oxide (CoO), copper(II) oxide (CuO), iron(II) oxide (FeO), magnesium oxide (MgO), nickel(II) oxide (NiO), palladium(II) oxide (PdO), strontium oxide (SrO), tin(II) oxide (SnO), titanium(II) oxide (TiO), vanadium(II) oxide (VO), zinc oxide (ZnO), aluminium oxide (Al₂O₃), antimony trioxide (Sb₂O₃), phosphorus trioxide (P₄O₆), phosphorous pentoxide (P₂O₅), rhenium trioxide (ReO₃), rhenium(VII) oxide (Re₂O₇), praseodymium(IV) oxide), (PrO₂), dipraseodymium trioxide (Pr₂O₃), neodynum oxide (Nd₂O₃), samarium(III) oxide (Sm₂O₃), europieum oxide, holmium(III) oxide (Ho₂O₃), thorium dioxide (ThO₂), uranium dioxide (UO₂), uranium trioxide (UO₃), barium oxide (BaO), plutonium dioxide (PuO₂), neptunium dioxide (NpO₂), lanthanum(III) oxide (La₂O₃), strontium oxide (SrO), boron oxide (B₂O₃), chromium(III) oxide (Cr₂O₃), gallium(III) oxide (Ga₂O₃), indium(III) oxide (In₂O₃), iron(III) oxide (Fe₂O₃), nickel(III) oxide (Ni₂O₃), thallium(III) oxide (Tl₂O₃), titanium(III) oxide (Ti₂O₃), tungsten(III) oxide (W₂O₃), vanadium(III) oxide (V₂O₃), yttrium(III) oxide (Y₂O₃), cerium(IV) oxide (CeO₂), chromium(IV) oxide (CrO₂), germanium dioxide (GeO₂), manganese(IV) oxide (MnO₂), ruthenium(IV) oxide (RuO₂), selenium dioxide (SeO₂), tellurium dioxide (TeO₂), tin dioxide (SnO₂), tungsten(IV) oxide (WO₂), vanadium(IV) oxide (VO₂), zirconium dioxide (ZrO₂), antimony pentoxide (Sb₂O₅), niobium pentoxide, tantalum pentoxide (Ta₂O₅), vanadium(V) oxide (V₂O₅), chromium trioxide (CrO₃), molybdenum(VI) oxide (MoO₃), selenium trioxide (SeO₃), tellurium trioxide (TeO₃), tungsten trioxide (WO₃), manganese(VII) oxide (Mn₂O₇), osmium tetroxide (OsO₄), and ruthenium tetroxide (RuO₄).

12. The inorganic proton conducting electrolyte according to any one of claims 2 to 9, wherein the zeolite is selected from the group consisting of chabazite Ca₂(Al₄Si₈O₂₄).13H₂O, eroionite Ca_{4.5}(Al₉Si₂₇O₇₂).27H₂O, mordenite Na(AlSi₅O₁₂).3H₂O, chinoptilolite, faujasite (Na₂,Ca)₃₀((Al,Si)₁₉₂O₃₈₄).260H₂O, phillipsite (K,Na)₅(Al₅Si₁₁O₃₂).10H₂O, zeolite A (Na₁₂Al₁₂Si₁₂O₄₈), zeolite L K₆Na₃Al₉Si₂₇O₇₂.21H₂O, Zeolite Y, zeolite X Na₂₀—Al₂O₃-2.5SiO₂ or ZSM-5 NaₙAlₙSi₉₆₋ₙO₁₉₂.16H₂O (0<n<27).

13. The inorganic proton conducting electrolyte according to claim 1, wherein the electrolyte comprises a mesoporous crystalline SiO₂ matrix and phosphotungstic acid (HPW) bound within the mesoporous crystalline SiO₂ matrix.

14. A fuel cell comprising an inorganic proton conducting electrolyte according to any one of claims 1 to 13.

15. A fuel cell according to claim 14, wherein the fuel cell operates at a temperature between about room temperature to about 600° C.

16. A method of manufacturing an inorganic proton conducting electrolyte according to any one of claims 1 to 13, comprising:
providing a sol comprising a heteropolyacid, at least one organometallic precursor and a surfactant;
aging the sol to obtain a gel;
calcining the mixture.

17. A method of manufacturing an inorganic proton conducting electrolyte according to any one of claims 1 to 13, comprising:
providing a mesoporous crystalline metal oxide matrix; and
impregnating the mesoporous crystalline metal oxide matrix with a heteropolyacid.

18. The method of claim 17, wherein the impregnation comprises:
subjecting the mesoporous crystalline metal oxide matrix to a vacuum; and
immersing the mesoporous crystalline metal oxide matrix in a solution comprising the heteropolyacid under a vacuum.

19. The method according to claim 16, wherein the aging step includes leaving the sol to evaporate, or heating the sol at a temperature between about 80 to about 150° C. at a pressure above atmospheric pressure.

20. The method according to claim 16, wherein the sol comprises an acid.

21. The method according to claim 20, wherein the molar ratio of the organometallic precursor to the acid is between about 100/1 to 5/1.

22. The method according to claim 16, wherein the organometallic precursor can be selected from the group consisting of silicon alkoxides, titanium alkoxides, aluminium alkoxides, zirconium alkoxides, titanium alkoxides, tungsten alkoxides, germanium alkoxides, indium alkoxides and mixtures thereof.

23. The method according to any one of claim 20 or 21, wherein the acid is selected from the group consisting of HCl, HNO₃, H₂SO₄, HBr, HClO₄, HCOOH, CH₃COOH and mixtures thereof.

24. The method according to any one of claims 16 or 19 to 23, wherein the calcination is carried out at a temperature of about 300° C. to about 650° C.

25. The method according to any one of claims 16 or 19 to 24, wherein the surfactant is selected from the group consisting of amphoteric surfactants, anionic surfactants, cationic surfactants, nonionic surfactants and mixtures thereof.

26. The method according to claim 25, wherein the anionic surfactant can be selected from the group consisting of sodium dodecyl sulfate (SDS), sodium pentane sulfonate, dehydrocholic acid, glycolithocholic acid ethyl ester, ammonium lauryl sulfate and other alkyl sulfate salts, sodium laureth sulfate, alkyl benzene sulfonate, soaps, fatty acid salts and mixtures thereof.

27. The method according to claim 25, wherein said nonionic surfactant is selected from the group consisting of poloaxamers, alkyl poly(ethylene oxide), diethylene glycol monohexyl ether, copolymers of poly(ethylene oxide) and poly(propylene oxide), hexaethylene glycol monohexadecyl ether, alkyl polyglucosides, digitonin, ethylene glycol monodecyl ether, cocamide MEA, cocamide DEA, cocamide TEA, fatty alcohols, sorbitan esters, oligomeric alkyl poly(ethylene oxides), alkyl-phenol poly(ethylene oxides) and mixtures thereof.

28. The method according to claim 25, wherein said nonionic surfactant is a poloaxamer or a mixture of different poloaxamers.

29. The method according to claim 28, wherein the poloaxamer is P123 or F127 or F108.

30. The method according to claim 25, wherein said cationic surfactant is selected from the group consisting of octadecyltrimethylammonium bromide (ODTMABr), cetyl trimethylammonium bromide (CTAB), dodecylethyldimethylammonium bromide, cetylpyridinium chloride (CPC), polyethoxylated tallow amine (POEA), hexadecyltrimethylammonium p-toluenesulfonate, benzalkonium chloride (BAC), benzethonium chloride (BZT), alkyltrimethyl quaternary ammonium surfactants, gemini surfactants, bolaform surfactants, tri-headgroup cationic surfactants, tetra-headgroup rigid bolaform surfactants, 3-aminopropyltrimethoxysilane (APS), N-trimethoxylsilylpropyl-N,N,N″-trimethylaminonium (TMAPS) and mixtures thereof.

31. The method according to claim 25, wherein said amphoteric surfactant is selected from the group consisting of dodecyl betaine, sodium 2,3-dimercaptopropanesulfonate monohydrate, dodecyl dimethylamine oxide, cocamidopropyl betaine, 3-[N,N-dimethyl(3-palmitoylaminopropyl)ammonio]-propanesulfonate, coco ampho glycinate and mixtures thereof.

32. The method according to any one of claims 16 or 19 to 31, wherein the molar ratio of the surfactant to the organometallic precursor in the sol is between about 0.5 mol % to about 10 mol %.

33. The method according to any one of claims 16 or 19 to 32, wherein the sol is applied to a support material before aging which is selected from the group consisting of a metal mesh, a metal foam, a porous metal substrate, and a porous metal support.

34. The method according to claim 33, wherein the sol is applied to the metal mesh or metal foam or porous metal substrate or porous metal support by spraying or pressing.

35. The method according to claim 33 or 34, wherein the metal mesh or metal foam or porous metal substrate or porous metal support is made of a material selected from the group consisting of titanium, antimony, cobalt, iron, manganese, silver, copper, lithium, rubidium, thallium, aluminium, barium, calcium, beryllium, magnesium, nickel, palladium, strontium, tin, vanadium, zinc, bismuth, boron, chromium, gallium, indium, tungsten, yttrium, cerium, germanium, ruthenium, selenium, tellurium, tantalum, niobium, molybdenum, alloys of the aforementioned metals and mixtures thereof.

36. An inorganic proton conducting electrolyte comprising a mesoporous crystalline metal oxide matrix and a heteropolyacid bound within the mesoporous crystalline metal oxide matrix; wherein the inorganic proton conducting electrolyte is obtained by a method according to any one of claims 16 to 35.
